(19) United States
(12) Patent Application Publication
(10) Pub. No.: US 2022/0365266 A1
(43) Pub. Date: Nov. 17, 2022

(54) APOCHROMATIC LIQUID CRYSTAL POLARIZATION HOLOGRAM DEVICE

(71) Applicant: Meta Platforms Technologies, LLC, Menlo Park, CA (US)

(72) Inventors: Hsien-Hui CHENG, Woodinville, WA (US); Lu LU, Kirkland, WA (US); Yitian DING, Redmond, WA (US); Yun-Han LEE, Redmond, WA (US); Junren WANG, Kirkland, WA (US); Mengfei WANG, Woodinville, WA (US)

(21) Appl. No.: 17/681,191

(22) Filed: Feb. 25, 2022

Related U.S. Application Data
(60) Provisional application No. 63/189,499, filed on May 17, 2021.

(51) Int. Cl. G02B 5/32; G02B 5/30

(52) U.S. Cl. CPC G02B 5/32; G02B 5/3083; G02B 5/3016

(57) ABSTRACT

A device is provided. The device includes a first polarization hologram element having a first operating wavelength band and configured to selectively backwardly diffract or transmit a first light associated with the first operating wavelength band based on a polarization of the first light. The device also includes a second polarization hologram element having a second operating wavelength band and stacked with the first polarization hologram. A thickness of the first polarization hologram element is configured based on a signal-to-noise ratio between a diffraction efficiency of the first polarization hologram element for the first light and a diffraction efficiency of the first polarization hologram element for a second light associated with the second operating wavelength band being greater than a predetermined value.

### CROSS REFERENCE TO RELATED APPLICATION

This application claims the benefit of priority to U.S. Provisional Application No. 63/189,499, filed on May 17, 2021. The content of the above-mentioned application is incorporated herein by reference in its entirety.

### TECHNICAL FIELD

The present disclosure generally relates to devices and, more specifically, to an apochromatic liquid crystal polarization hologram device.

### BACKGROUND

Liquid crystal polarization holograms (“LCPHs”) refer to the intersection of liquid crystal devices and polarization holograms. Liquid crystal displays (“LCDs”), having grown to a trillion dollar industry over the past decades, are the most successful example of liquid crystal devices. The LCD industry has made tremendous investments to scale manufacturing, from the low end G2.5 manufacturing line to the high end G10.5+ to meet the market demands for displays. However, the LCD industry has recently faced competition from organic light-emitting diodes (“OLED”), e-paper and other emerging display technologies, which has flattened the growth rate of LCD industry and has rendered significant early generation capacity redundant. This provides an opportunity to repurpose the LCD idle capacity and existing supply chain to manufacture novel LC optical devices characterized by their polarization holograms.

LCPHs have features such as small thickness (˜1 um), light weight, compactness, large aperture, high efficiency, simple fabrication, etc. Thus, LCPHs have gained increasing interests in optical device and system applications, e.g., near-eye displays (“NEDs”), head-up displays (“HUDs”), head-mounted displays (“HMDs”), smart phones, laptops, televisions, or vehicles, etc. For example, LCPHs may be used for addressing accommodation-vergence conflict, enabling thin and highly efficient eye-tracking and depth sensing in space constrained optical systems, developing optical combiners for image formation, correcting chromatic aberrations for image resolution enhancement of refractive optical elements in compact optical systems, and improving the efficiency and reducing the size of optical systems.

### SUMMARY OF THE DISCLOSURE

Consistent with an aspect of the present disclosure, a device is provided. The device includes a first polarization hologram element having a first operating wavelength band and configured to selectively backwardly diffract or transmit a first light associated with the first operating wavelength band based on a polarization of the first light. The device also includes a second polarization hologram element having a second operating wavelength band and stacked with the first polarization hologram. A thickness of the first polarization hologram element is configured based on a signal-to-noise ratio between a diffraction efficiency of the first polarization hologram element for the first light and a diffraction efficiency of the first polarization hologram element for a second light associated with the second operating wavelength band being greater than a predetermined value.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A schematically illustrates a three-dimensional (“3D”) view of a liquid crystal polarization hologram (“LCPH”) element, according to an embodiment of the present disclosure;

FIGS. 1B-1D schematically illustrate various diagrams of a portion of the LCPH element shown in FIG. 1A, showing in-plane orientations of optically anisotropic molecules in the LCPH element, according to various embodiments of the present disclosure;

FIG. 1E schematically illustrates a diagram of a portion of the LCPH element shown in FIG. 1A, showing out-of-plane orientations of optically anisotropic molecules in the LCPH element, according to an embodiment of the present disclosure;

FIG. 1F schematically illustrates diffraction and transmission of the LCPH element shown in FIG. 1A functioning as a reflective polarization volume hologram (“R-PVH”) element, for a polychromatic, circularly polarized light, according to an embodiment of the present disclosure;

FIG. 1G schematically illustrates a diagram of the LCPH element shown in FIG. 1A functioning as an R-PVH lens, according to an embodiment of the present disclosure;

FIG. 2A schematically illustrates a diagram of an apochromatic R-PVH device, according to an embodiment of the present disclosure;

FIG. 2B schematically illustrates a diagram of an apochromatic R-PVH device, according to an embodiment of the present disclosure;

FIG. 3A schematically illustrates diffraction and transmission of a conventional R-PVH element for a polychromatic, circularly polarized light;

FIG. 3B schematically illustrates a diagram showing a relationship between a diffraction efficiency and a wavelength of an incident light of the conventional R-PVH element shown in FIG. 3A;

FIG. 3C schematically illustrates a diagram showing of a conventional PVH device including a stack of three conventional R-PVH elements;

FIG. 4A schematically illustrates a diagram of an apochromatic R-PVH device, according to an embodiment of the present disclosure;

FIG. 4B schematically illustrates a diagram of an apochromatic R-PVH device, according to an embodiment of the present disclosure;

FIG. 5 schematically illustrates a diagram of an optical system, according to an embodiment of the present disclosure;

FIG. 6A schematically illustrates a diagram of an optical system, according to an embodiment of the present disclosure;

FIG. 6B schematically illustrates a cross-sectional view of an optical path of an image light propagating through the optical system shown in FIG. 6A, according to an embodiment of the present disclosure;

FIG. 7A illustrates a schematic diagram of a near-eye display (“NED”), according to an embodiment of the present disclosure; and

FIG. 7B illustrates a schematic cross sectional view of half of the NED shown in FIG. 7A, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable.

The phrases “in-plane direction,” “in-plane orientation,” “in-plane rotation,” “in-plane alignment pattern,” and “in-plane pitch” refer to a direction, an orientation, a rotation, an alignment pattern, and a pitch in a plane of a film or a layer (e.g., a surface plane of the film or layer, or a plane parallel to the surface plane of the film or layer), respectively. The term “out-of-plane direction” or “out-of-plane orientation” indicates a direction or orientation that is non-parallel to the plane of the film or layer (e.g., perpendicular to the surface plane of the film or layer, e.g., perpendicular to a plane parallel to the surface plane). For example, when an “in-plane” direction or orientation refers to a direction or orientation within a surface plane, an “out-of-plane” direction or orientation may refer to a thickness direction or orientation perpendicular to the surface plane, or a direction or orientation that is not parallel with the surface plane.

The term “orthogonal” as used in “orthogonal polarizations” or the term “orthogonally” as used in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

In the present disclosure, an angle of a beam (e.g., a diffraction angle of a diffracted beam or an incidence angle of an incident beam) with respect to a normal of a surface can be defined as a positive angle or a negative angle, depending on the angular relationship between a propagating direction of the beam and the normal of the surface. For example, when the propagating direction of the beam is clockwise (or counter-clockwise) from the normal, the angle of the propagating direction may be defined as a positive angle, and when the propagating direction of the beam is counter-clockwise (or clockwise) from the normal, the angle of the propagating direction may be defined as a negative angle.

The wavelength bands, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, block or the like that describes processing of a light means that a majority portion, including all, of a light is transmitted, reflected, diffracted, or blocked, etc. The majority portion may be a predetermined percentage (greater than 50%) of the entire light, such as 100%, 98%, 90%, 85%, 80%, etc., which may be determined based on specific application needs.

Among liquid crystal polarization hologram (“LCPH”) elements, liquid crystal (“LC”) based geometric phase (“GP”) or Pancharatnam-Berry phase (“PBP”) elements and polarization volume hologram (“PVH”) elements have been extensively studied. A PBP element may modulate a circularly polarized light based on a phase profile provided through a geometric phase. A PBP element may split a linearly polarized light or an unpolarized light into two circularly polarized lights with opposite handednesses and symmetric deflecting directions. A PVH element may modulate a circularly polarized light based on Bragg diffraction. A PVH element may split a linearly polarized light or an unpolarized light into two circularly polarized lights with opposite handednesses or the same handedness. For example, a PVH element may substantially diffract one circularly polarized component while substantially transmit the other circularly polarized component of a linearly polarized light or an unpolarized light. Orientations of LC molecules in the PBP element and the R-PVH element may exhibit rotations in three-dimensions, and may have similar in-plane orientational patterns.

PVH elements may be configured to have a substantially high diffraction efficiency (e.g., ≥98%), and may be implemented as various optical devices, such as gratings, lenses, etc. Optical responses of R-PVH elements may be wavelength dependent. For example, a diffraction angle of a PVH grating, and a focus distance of a PVH lens may vary with an incidence wavelength. For example, for a polychromatic incident light including blue, green, and red portions, a PVH grating may diffract blue, green, and red portions in different diffraction angles, and a PVH lens may focus blue, green, and red portions to different focal distances, resulting in chromatic aberrations. The chromatic aberrations may reduce the optical performance of a system that includes a PVH element receiving a polychromatic light.

In view of the limitations in conventional technologies, the present disclosure provides apochromatic, superfast (F #≤0.5 for a lens, beam deflection angle≥45° for a beam deflector), and highly efficient (≥98%) PVH devices or components. In some embodiments, the device comprises a first polarization hologram element having a first operating wavelength band and configured to selectively backwardly diffract or transmit a first light associated with the first operating wavelength band based on a polarization of the first light. The device also comprises a second polarization hologram element having a second operating wavelength band and stacked with the first polarization hologram. A thickness of the first polarization hologram element is configured based on a signal-to-noise ratio between a diffraction efficiency of the first polarization hologram element for the first light and a diffraction efficiency of the first polarization hologram element for a second light associated with the second operating wavelength band being greater than a predetermined value. In some embodiments, the first light and the second light have a same predetermined polarization. In some embodiments, the predetermined value relating to the signal-to-noise ratio is 100.

In some embodiments, the second polarization hologram element is configured to selectively backwardly diffract or transmit the second light based on a polarization of the second light. A thickness of the second polarization hologram element is configured based on a signal-to-noise ratio between a diffraction efficiency of the second polarization hologram element for the second light and a diffraction efficiency of the second polarization hologram element for the first light being greater than the predetermined value.

In some embodiments, the first polarization hologram element is configured to backwardly diffract the first light in a predetermined diffraction angle when the polarization of the first light is a predetermined polarization, and the second polarization hologram element is configured to backwardly diffract the second light in the predetermined diffraction angle when the polarization of the second light is the predetermined polarization. In some embodiments, the first polarization hologram element is configured to backwardly diffract to focus the first light to a predetermined focal point when the polarization of the first light is the predetermined polarization, and the second polarization hologram element is configured to backwardly diffract to focus the second light to the predetermined focal point when the polarization of the second light is the predetermined polarization.

In some embodiments, the first polarization hologram element and the second polarization hologram element are reflective polarization volume hologram (“R-PVH”) elements. In some embodiments, the R-PVH elements include R-PVH gratings or R-PVH lenses. In some embodiments, the first operating wavelength band and the second first operating wavelength band correspond to a first color channel and a second color channel, respectively.

In some embodiments, the device further comprises a compensation plate disposed between the first polarization hologram element and the second polarization hologram element. In some embodiments, the compensation plate is an A-plate.

In some embodiments, the device further comprises a third polarization hologram element having a third operating wavelength band and stacked with the first and second polarization hologram elements. The thickness of the first polarization hologram element is configured also based on a signal-to-noise ratio between the diffraction efficiency of the first polarization hologram element for the first light and a diffraction efficiency of the first polarization hologram element for a third light associated with the third operating wavelength band being greater than the predetermined value. In some embodiments, the first, second, and third lights have a same predetermined polarization.

In some embodiments, the second polarization hologram element is configured to selectively backwardly diffract or transmit the second light based on a polarization of the second light. A thickness of the second polarization hologram element is configured based on a signal-to-noise ratio between a diffraction efficiency of the second polarization hologram element for the second light and a diffraction efficiency of the second polarization hologram element for the third light being greater than the predetermined value.

In some embodiments, the thickness of the second polarization hologram element is configured also based on a signal-to-noise ratio between a diffraction efficiency of the second polarization hologram element for the second light and a diffraction efficiency of the second polarization hologram element for the first light being greater than the predetermined value.

In some embodiments, the third polarization hologram element is configured to selectively backwardly diffract or transmit the third light based on a polarization of the third light. A thickness of the third polarization hologram element is configured based on a signal-to-noise ratio between a diffraction efficiency of the third polarization hologram element for the third light and a diffraction efficiency of the third polarization hologram element for at least one of the first light or the second light being greater than the predetermined value.

In some embodiments, the first polarization hologram element is configured to backwardly diffract the first light in a predetermined diffraction angle when the polarization of the first light is a predetermined polarization. The second polarization hologram element is configured to backwardly diffract the second light in the predetermined diffraction angle when the polarization of the second light is the predetermined polarization. The third polarization hologram element is configured to backwardly diffract the third light in the predetermined diffraction angle when the polarization of the third light is the predetermined polarization.

In some embodiments, the first polarization hologram element is configured to backwardly diffract to focus the first light to a predetermined focal point when the polarization of the first light is a predetermined polarization. The second polarization hologram element is configured to backwardly diffract to focus the second light to the predetermined focal point when the polarization of the second light is the predetermined polarization. The third polarization hologram element is configured to backwardly diffract to focus the third light to the predetermined focal point when the polarization of the third light is the predetermined polarization.

In some embodiments, the device further comprises a first compensation plate disposed between the first polarization hologram element and the second polarization hologram element, and a second compensation plate disposed between the second polarization hologram element and the third polarization hologram element. In some embodiments, the first compensation plate is configured to compensate for a polarization deviation of the second light after the second light propagates through the first polarization hologram element. The second compensation plate is configured to compensate for the polarization deviation of the third light after the third light propagates through the first polarization hologram element, the first compensation plate, and the second polarization hologram element.

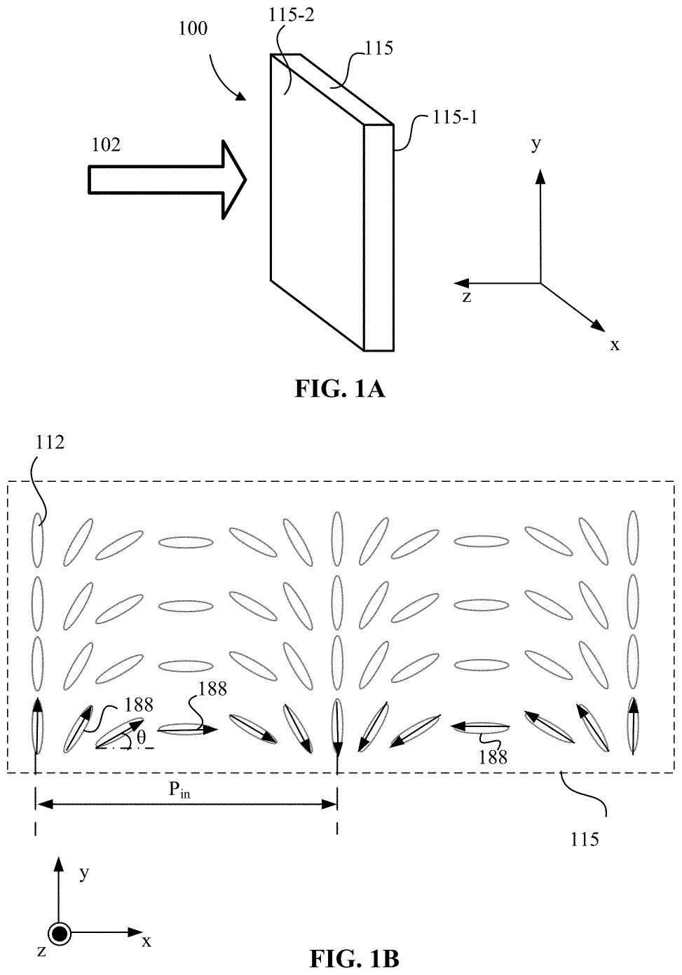

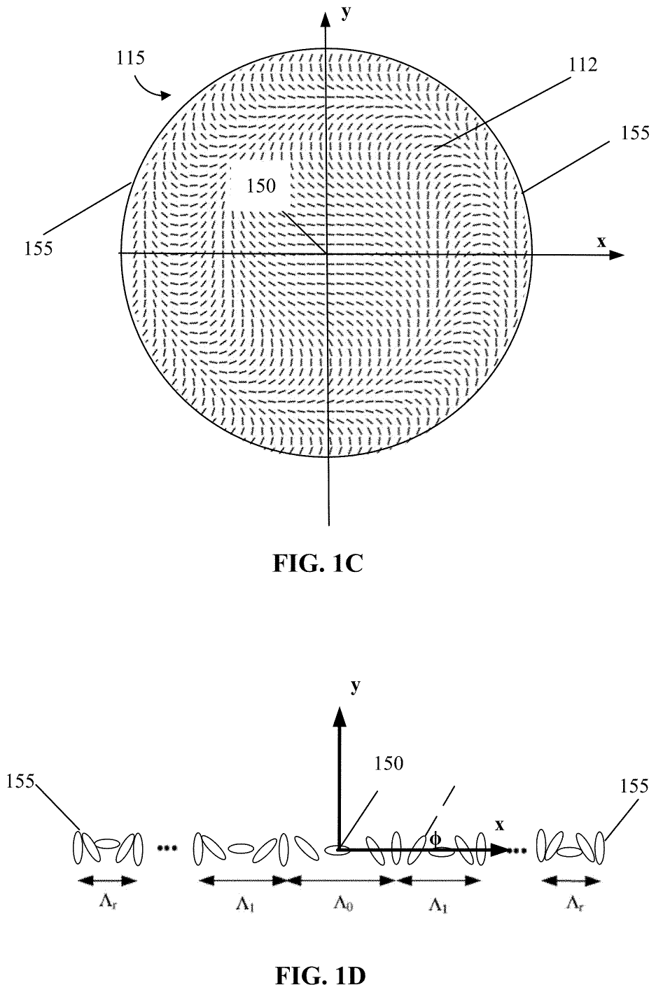

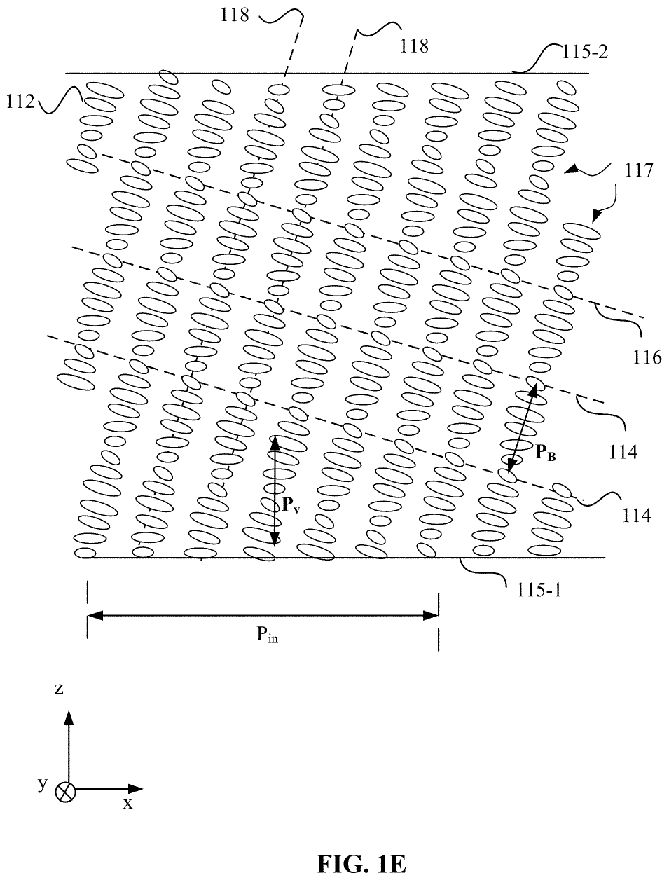

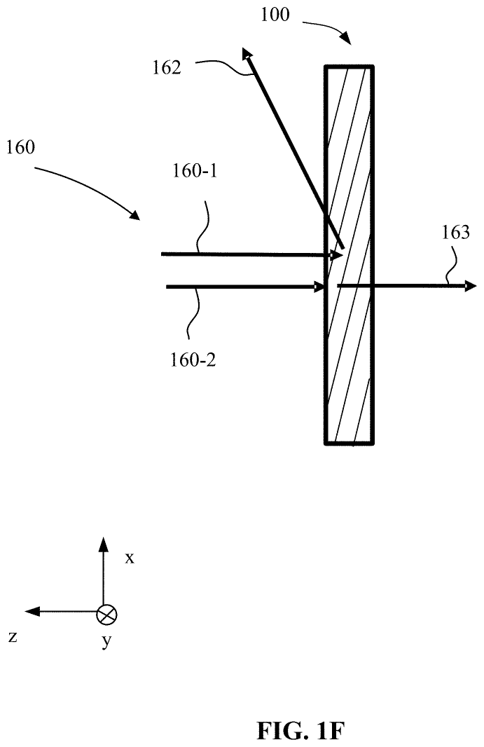

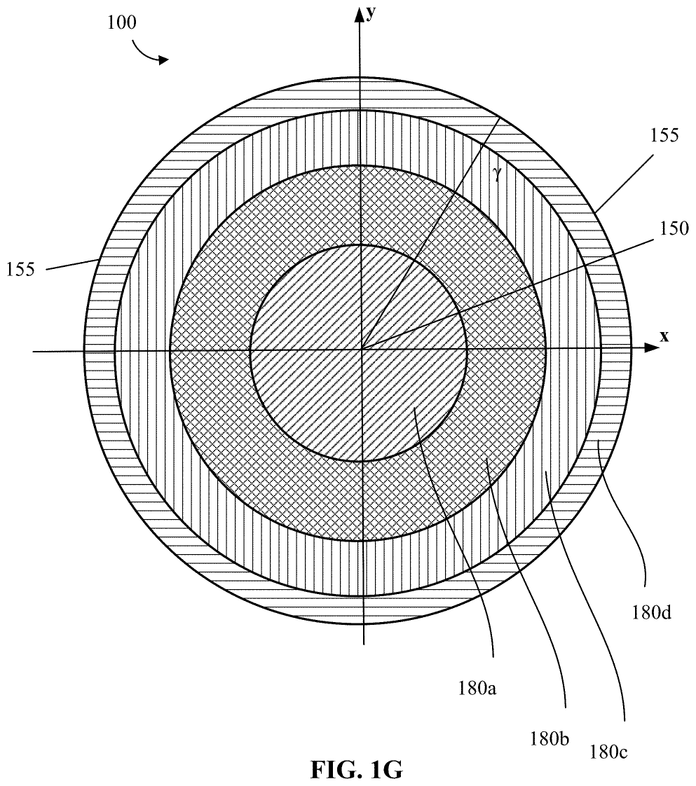

FIG. 1A illustrates a schematic three-dimensional (“3D”) view of a liquid crystal polarization hologram (“LCPH”) element 100 with a light 102 incident onto the LCPH element 100 along a −z-axis, according to an embodiment of the present disclosure. FIGS. 1B-1D schematically illustrate various views of a portion of the LCPH element 100 shown in FIG. 1A, showing in-plane orientations of optically anisotropic molecules in the LCPH element 100, according to various embodiments of the present disclosure. FIG. 1E schematically illustrates a diagram of a portion of the LCPH element 100 shown in FIG. 1A, showing out-of-plane orientations of optically anisotropic molecules in the LCPH element 100, according to an embodiment of the present disclosure.

As shown in FIG. 1A, although the LCPH element 100 is shown as a rectangular plate shape for illustrative purposes, the LCPH element 100 may have any suitable shape, such as a circular shape. In some embodiments, one or both surfaces along the light propagating path of the light 102 may have curved shapes. In some embodiments, the LCPH element 100 may be fabricated based on a birefringent medium, e.g., liquid crystal (“LC”) materials, which may have an intrinsic orientational order of optically anisotropic molecules that may be locally controlled during the fabrication process. In some embodiments, the LCPH element 100 may be fabricated based on a photosensitive polymer, such as an amorphous polymer, an LC polymer, etc., which may generate an induced (e.g., photo-induced) optical anisotropy and/or an induced (e.g., photo-induced) optic axis orientation.

In some embodiments, the LCPH element 100 may include a birefringent medium (e.g., an LC material) in a form of a layer, which may be referred to as a birefringent medium layer (e.g., an LC layer) 115. The birefringent medium layer 115 may have a first surface 115-1 on one side and a second surface 115-2 on an opposite side. The first surface 115-1 and the second surface 115-2 may be surfaces along the light propagating path of the incident light 102. The birefringent medium layer 115 may include optically anisotropic molecules (e.g., LC molecules) configured with a three-dimensional (“3D”) orientational pattern to provide a polarization selective optical response. In some embodiments, an optic axis of the LC material may be configured with a spatially varying orientation in at least one in-plane direction. For example, the optic axis of the LC material may periodically or non-periodically vary in at least one in-plane linear direction, in at least one in-plane radial direction, in at least one in-plane circumferential (e.g., azimuthal) direction, or a combination thereof. The LC molecules may be configured with an in-plane orientation pattern, in which the directors of the LC molecules may periodically or non-periodically vary in the at least one in-plane direction. In some embodiments, the optic axis of the LC material may also be configured with a spatially varying orientation in an out-of-plane direction. The directors of the LC molecules may also be configured with spatially varying orientations in an out-of-plane direction. For example, the optic axis of the LC material (or directors of the LC molecules) may twist in a helical fashion in the out-of-plane direction.

FIGS. 1B-1D schematically illustrate x-y sectional views of a portion of the LCPH element 100 shown in FIG. 1A, showing in-plane orientations of the optically anisotropic molecules 112 in the LCPH element 100, according to various embodiments of the present disclosure. For discussion purposes, rod-like LC molecules 112 are used as examples of the optically anisotropic molecules 112 of the birefringent medium layer 115. The rod-like LC molecule 112 may have a longitudinal axis (or an axis in the length direction) and a lateral axis (or an axis in the width direction). The longitudinal axis of the LC molecule 112 may be referred to as a director of the LC molecule 112 or an LC director. An orientation of the LC director may determine a local optic axis orientation or an orientation of the optic axis at a local point of the birefringent medium layer 115. The term “optic axis” may refer to a direction in a crystal. A light propagating in the optic axis direction may not experience birefringence (or double refraction). An optic axis may be a direction rather than a single line: lights that are parallel to that direction may experience no birefringence. The local optic axis may refer to an optic axis within a predetermined region of a crystal. For illustrative purposes, the LC directors of the LC molecules 112 shown in FIGS. 1B-1D are presumed to be in the surface of the birefringent medium layer 115 or in a plane parallel with the surface with substantially small tilt angles with respect to the surface.

FIG. 1B schematically illustrates an x-y sectional view of a portion of the LCPH element 100, showing a periodic in-plane orientation pattern of the orientations of the LC directors (indicated by arrows 188 in FIG. 1B) of the LC molecules 112 located in close proximity to or at a surface (e.g., at least one of the first surface 115-1 or the second surface 115-2) of the birefringent medium layer 115. The orientations of the LC directors located in close proximity to or at the surface of the birefringent medium layer 115 may exhibit a periodic rotation in at least one in-plane direction (e.g., an x-axis direction). The periodically varying in-plane orientations of the LC directors form a pattern. The in-plane orientation pattern of the LC directors shown in FIG. 1B may also be referred to as a grating pattern. Accordingly, the LCPH element 100 may function as a polarization selective grating, e.g., a PVH grating.

As shown in FIG. 1B, the LC molecules 112 located in close proximity to or at a surface (e.g., at least one of the first surface 115-1 or the second surface 115-2) of the birefringent medium layer 115 may be configured with orientations of LC directors continuously changing (e.g., rotating) in a predetermined direction (e.g., an x-axis direction) along the surface (or in a plane parallel with the surface). The continuous rotation of orientations of the LC directors may form a periodic rotation pattern with a uniform (e.g., same) in-plane pitch Pᵢₙ. The predetermined direction may be any suitable direction along the surface (or in a plane parallel with the surface) of the birefringent medium layer 115. For illustrative purposes, FIG. 1B shows that the predetermined direction is the x-axis direction. The predetermined direction may be referred to as an in-plane direction, the pitch Pᵢₙ along the in-plane direction may be referred to as an in-plane pitch or a horizontal pitch. The pattern with the uniform (or same) in-plane pitch Pᵢₙ may be referred to as a periodic LC director in-plane orientation pattern. The in-plane pitch Pᵢₙ is defined as a distance along the in-plane direction (e.g., the x-axis direction) over which the orientations of the LC directors exhibit a rotation by a predetermined value (e.g., 180°). In other words, in a region substantially close to (including at) the surface of the birefringent medium layer 115, local optic axis orientations of the birefringent medium layer 115 may vary periodically in the in-plane direction (e.g., the x-axis direction) with a pattern having the uniform (or same) in-plane pitch Pᵢₙ.

In addition, in regions located in close proximity to or at the surface (e.g., at least one of the first surface 115-1 or the second surface 115-2) of the birefringent medium layer 115, the orientations of the directors of the LC molecules 112 may exhibit a rotation in a predetermined rotation direction, e.g., a clockwise direction or a counter-clockwise direction. Accordingly, the rotation of the orientations of the directors of the LC molecules 112 in regions located in close proximity to or at the surface of the birefringent medium layer 115 may exhibit a handedness, e.g., right handedness or left handedness. In the embodiment shown in FIG. 1B, in regions located in close proximity to or at the surface of the birefringent medium layer 115, the orientations of the directors of the LC molecules 112 may exhibit a rotation in a clockwise direction. Accordingly, the rotation of the orientations of the directors of the LC molecules 112 in regions located in close proximity to or at the surface of the birefringent medium layer 115 may exhibit a left handedness.

Although not shown, in some embodiments, in regions located in close proximity to or at the surface (e.g., at least one of the first surface 115-1 or the second surface 115-2) of the birefringent medium layer 115, the orientations of the directors of the LC molecules 112 may exhibit a rotation in a counter-clockwise direction. Accordingly, the rotation of the orientations of the directors of the LC molecules 112 in regions located in close proximity to or at the surface of the birefringent medium layer 115 may exhibit a right handedness. Although not shown, in some embodiments, in regions located in close proximity to or at the surface of the birefringent medium layer 115, domains in which the orientations of the directors of the LC molecules 112 exhibit a rotation in a clockwise direction (referred to as domains DL) and domains in which the orientations of the directors of the LC molecules 112 exhibit a rotation in a counter-clockwise direction (referred to as domains D_{R}) may be alternatingly arranged in at least one in-plane direction, e.g., in x-axis and y-axis directions.

FIG. 1C schematically illustrates an x-y sectional view of a portion of the LCPH element 100, showing a radially varying in-plane orientation pattern of the orientations of the LC directors of the LC molecules 112 located in close proximity to or at a surface (e.g., at least one of the first surface 115-1 or the second surface 115-2) of the birefringent medium layer 115 shown in FIG. 1A. FIG. 1D illustrates a section of the in-plane orientation pattern taken along an x-axis in the birefringent medium layer 115 shown in FIG. 1C, according to an embodiment of the present disclosure. In a region in close proximity to or at a surface (e.g., at least one of the first surface 115-1 or the second surface 115-2) of the birefringent medium layer 115, the orientations of the optic axis of the birefringent medium layer 115 may exhibit a continuous rotation in at least two opposite in-plane directions from a center of the birefringent medium layer 115 to opposite peripheries of the birefringent medium layer 115 with a varying pitch. In some embodiments, the in-plane orientation pattern of the orientations of the LC directors shown in FIG. 1C may also be referred to as a lens pattern. Accordingly, the LCPH element 100 with the LC director orientations shown in FIG. 1C may function as a polarization selective lens, e.g., a PVH lens.

As shown in FIG. 1C, the orientations of the LC molecules 112 located in close proximity to or at a surface (e.g., at least one of the first surface 115-1 or the second surface 115-2) of the birefringent medium layer 115 may be configured with an in-plane orientation pattern having a varying pitch in at least two opposite in-plane directions from a lens center 150 to opposite lens peripheries 155. For example, the orientations of the LC directors of LC molecules 112 located in close proximity to or at the surface of the birefringent medium layer 115 may exhibit a continuous rotation in at least two opposite in-plane directions (e.g., a plurality of opposite radial directions) from the lens center 150 to the opposite lens peripheries 155 with a varying pitch. The orientations of the LC directors from the lens center 150 to the opposite lens peripheries 155 may exhibit a rotation in a same rotation direction (e.g., clockwise, or counter-clockwise). A pitch Λ of the in-plane orientation pattern may be defined as a distance in the in-plane direction (e.g., a radial direction) over which the orientations of the LC directors (or azimuthal angles ϕ of the LC molecules 112) change by a predetermined angle (e.g., 180°) from a predetermined initial state.

As shown in FIG. 1D, according to the LC director field along the x-axis direction, the pitch Λ may be a function of the distance from the lens center 150. The pitch Λ may monotonically decrease from the lens center 150 to the lens peripheries 155 in the at least two opposite in-plane directions (e.g., two opposite radial directions) in the x-y plane, e.g., Λ₀>Λ₁> . . . >Λᵣ. Λ₀ is the pitch at a central region of the lens pattern, which may be the largest. The pitch Λᵣ is the pitch at a periphery region (e.g., periphery 155) of the lens pattern, which may be the smallest. In some embodiments, the azimuthal angle ϕ of the LC molecule 112 may change in proportional to the distance from the lens center 150 to a local point of the birefringent medium layer 115 at which the LC molecule 112 is located.

The in-plane orientation patterns of the LC directors shown in FIGS. 1B-1D are for illustrative purposes. The LCPH element 100 may have any suitable in-plane orientation patterns of the LC directors. For illustrative purposes, FIGS. 1C and 1D show an in-plane orientation pattern of the LC directors when the LCPH element 100 is a PBP or PVH lens functioning as an on-axis spherical lens. In some embodiments, the LCPH element 100 may be a PBP or PVH lens functioning as an off-axis spherical lens, a cylindrical lens, an aspheric lens, or a freeform lens, etc.

FIG. 1E schematically illustrates a y-z sectional view of a portion of the LCPH element 100, showing out-of-plane orientations of the LC directors of the LC molecules 112 in the LCPH element 100, according to an embodiment of the present disclosure. For discussion purposes, FIG. 1E schematically illustrates out-of-plane (e.g., along z-axis direction) orientations of the LC directors of the LC molecules 112 when the in-plane (e.g., in a plane parallel to the x-y plane) orientation pattern is a periodic in-plane orientation pattern shown in FIG. 1B.

As shown in FIG. 1E, within a volume of the birefringent medium layer 115, the LC molecules 112 may be arranged in a plurality of helical structures 117 with a plurality of helical axes 118 and a helical pitch Pₕ along the helical axes. The azimuthal angles of the LC molecules 112 arranged along a single helical structure 117 may continuously vary around a helical axis 118 in a predetermined rotation direction, e.g., clockwise direction or counter-clockwise direction. In other words, the orientations of the LC directors of the LC molecules 112 arranged along a single helical structure 117 may exhibit a continuous rotation around the helical axis 118 in a predetermined rotation direction. That is, the azimuthal angles associated of the LC directors may exhibit a continuous change around the helical axis in the predetermined rotation direction. Accordingly, the helical structure 117 may exhibit a handedness, e.g., right handedness or left handedness. The helical pitch Pₕ may be defined as a distance along the helical axis 118 over which the orientations of the LC directors exhibit a rotation around the helical axis 118 by 360°, or the azimuthal angles of the LC molecules vary by 360°.

In the embodiment shown in FIG. 1E, the helical axes 118 may be tilted or slanted with respect to the first surface 115-1 and/or the second surface 115-2 of the birefringent medium layer 115. For example, the helical axes 118 of the helical structures 117 may have an acute angle or obtuse angle with respect to the first surface 115-1 and/or the second surface 115-2 of the birefringent medium layer 115. In some embodiments, the LC directors of the LC molecule 112 may be substantially orthogonal to the helical axes 118. In some embodiments, the LC directors of the LC molecule 112 may be tilted with respect to the helical axes 118 at an acute angle. The birefringent medium layer 115 may have a vertical pitch Pᵥ, which may be defined as a distance along the thickness direction of the birefringent medium layer 115 over which the orientations of the LC directors of the LC molecules 112 exhibit a rotation around the helical axis 118 by 180° (or the azimuthal angles of the LC directors vary by 180°).

As shown in FIG. 1E, the LC molecules 112 from the plurality of helical structures 117 having a first same orientation (e.g., same tilt angle and azimuthal angle) may form a first series of parallel refractive index planes 114 periodically distributed within the volume of the birefringent medium layer 115. Although not labeled, the LC molecules 112 with a second same orientation (e.g., same tilt angle and azimuthal angle) different from the first same orientation may form a second series of parallel refractive index planes periodically distributed within the volume of the birefringent medium layer 115. Different series of parallel refractive index planes may be formed by the LC molecules 112 having different orientations. In the same series of parallel and periodically distributed refractive index planes 114, the LC molecules 112 may have the same orientation and the refractive index may be the same. Different series of refractive index planes 114 may correspond to different refractive indices. When the number of the refractive index planes 114 (or the thickness of the birefringent medium layer) increases to a sufficient value, Bragg diffraction may be established according to the principles of volume gratings. Thus, the periodically distributed refractive index planes 114 may also be referred to as Bragg planes 114.

In some embodiments, as shown in FIG. 1E, the refractive index planes 114 may be slanted with respect to the first surface 115-1 or the second surface 115-2. In some embodiments, the refractive index planes 114 may be perpendicular to or parallel with the first surface 115-1 or the second surface 115-2. Within the birefringent medium layer 115, there may exist different series of Bragg planes. A distance (or a period) between adjacent Bragg planes 114 of the same series may be referred to as a Bragg period P_{B}. The different series of Bragg planes formed within the volume of the birefringent medium layer 115 may produce a varying refractive index profile that is periodically distributed in the volume of the birefringent medium layer 115. The birefringent medium layer 115 may diffract an input light satisfying a Bragg condition through Bragg diffraction.

As shown in FIG. 1E, the birefringent medium layer 115 may also include a plurality of LC molecule director planes (or molecule director planes) 116 arranged in parallel with one another within the volume of the birefringent medium layer 115. An LC molecule director plane (or an LC director plane) 116 may be a plane formed by or including the LC directors of the LC molecules 112. In the embodiment shown in FIG. 1E, an angle θ (not shown) between the LC director plane 116 and the Bragg plane 114 may be substantially 0° or 180°. That is, the LC director plane 116 may be substantially parallel with the Bragg plane 114. In the example shown in FIG. 1E, the orientations of the directors in the molecule director plane 116 may be substantially the same. The LCPH element 100 including the birefringent medium layer 115 shown in FIG. 1E may function as a reflective PVH (“R-PVH”) element, e.g., an R-PVH grating. An R-PVH lens may be considered as an R-PVH grating with an optical power.

In some embodiments, the LCPH element 100 may function as an R-PVH element (also referred to as 100 for discussion purposes). The R-PVH element 100 may have a designed operating wavelength range (or band). For discussion purposes, a light having a wavelength range within the designed operating wavelength range (or band) of the R-PVH element 100 may also be referred to as a light associated with the operating wavelength range (or band) of the R-PVH element 100. A light having a wavelength outside of the operating wavelength band of the R-PVH element 100 may be referred to as a light not associated with the operating wavelength range (or band) of the R-PVH element 100.

For a circularly polarized light associated with the operating wavelength range, the R-PVH element 100 may selectively backwardly diffract or transmit (with negligible diffraction) the circularly polarized light, depending on the handedness of the circularly polarized light. In some embodiments, referring to FIG. 1E, the handedness of the helical structures 117 may define the polarization selectivity of the R-PVH element 100 for a circularly polarized light associated with the operating wavelength range. In some embodiments, the R-PVH element 100 may substantially backwardly diffract the circularly polarized light, when the circularly polarized light has a handedness that is the same as the handedness of the helical structures 117, and substantially transmit (e.g., with negligible diffraction) the circularly polarized light, when the circularly polarized light has a handedness that is opposite to the handedness of the helical structures 117.

In some embodiments, depending on the handedness of the helical structures 117 within the R-PVH element 100, the R-PVH element 100 may be referred to as a left-handed or right-handed R-PVH grating. For example, a left-handed R-PVH element may be configured to substantially backwardly diffract a left-handed circularly polarized (“LHCP”) light associated with the operating wavelength band, and substantially transmit (e.g., with negligible diffraction) a right-handed circularly polarized (“RHCP”) light associated with the operating wavelength band. A right-handed R-PVH element may be configured to substantially backwardly diffract an RHCP light associated with the operating wavelength band, and substantially transmit (e.g., with negligible diffraction) an LHCP light associated with the operating wavelength band.

In some embodiments, for a light (e.g., circularly polarized light) having a wavelength outside of the operating wavelength band (or not associated with the operating wavelength band) of the R-PVH element 100, the R-PVH element 100 may partially backwardly diffract and partially transmit the circularly polarized light, for example, independent of the polarization of the light (e.g., independent of the handedness of the circularly polarized light). In the disclosed embodiments, the thickness of the R-PVH element 100 may be specifically configured or designed to reduce the backward diffraction and thus, increase the transmission of the light (e.g., circularly polarized light) having the wavelength outside of the operating wavelength band of the R-PVH element 100. The principle for specifically configuring or designing the thickness of the R-PVH element 100 is described below in detail. For discussion purposes, in the following examples, a circularly polarized light having a wavelength outside of the operating wavelength band is used as an example of a light having a wavelength outside of the operating wavelength band.

Referring to FIG. 1E, the birefringent medium layer 115 or R-PVH element 100 may diffract an input light satisfying a Bragg condition through Bragg diffraction. Bragg diffraction may be a consequence of interference between waves (or lights) reflected from different Bragg planes 114. In some embodiments, the thickness of the R-PVH element 100 may be specifically configured or designed, such that the number of Bragg planes (e.g., 114 shown in FIG. 1E) formed within the volume of the R-PVH element 100 may be configured to be a predetermined number. Each of the predetermined number of Bragg planes may reflect the circularly polarized light having the wavelength outside of the operating wavelength band. The lights reflected from the predetermined number of Bragg planes may interfere destructively with one another, or may interfere with one another to form a destructive interference, such that the R-PVH element 100 may be configured to reduce the backward diffraction of the circularly polarized light having the wavelength outside of the operating wavelength band to be below a predetermined level.

For example, in some embodiments, the thickness of the R-PVH element 100 may be specifically configured or designed, such that the R-PVH element 100 may be configured to backwardly diffract the circularly polarized light having the wavelength outside of the operating wavelength band, with a backward diffraction efficiency less than a first predetermined value, or with a signal-to-noise (S/N ratio) greater than a second predetermined value. The S/N ratio of the R-PVH element 100 may be referred to as a ratio between a backward diffraction efficiency of the R-PVH element 100 for a first circularly polarized light associated with the operating wavelength band (i.e., for a signal light) and a backward diffraction efficiency of the R-PVH element 100 for a second circularly polarized light having a wavelength outside of the operating wavelength band (i.e., for a noise light). A larger S/N ratio may indicate a lower diffraction efficiency for the noise light and a higher diffraction efficiency for the signal light. Both of the first and second circularly polarized lights may have a handedness that is the same as the handedness of the helical structures 117 within the R-PVH element 100. For example, when the R-PVH element 100 is a left-handed (or right-handed) R-PVH element, both of the first and second circularly polarized lights may be LHCP (or RHCP) lights.

The S/N ratio of the R-PVH element 100 may be calculated when the R-PVH element 100 backwardly diffracts a polychromatic light including a first portion (e.g., a first circularly polarized light) associated with the operating wavelength band (a signal light) and a second portion (e.g., a second circularly polarized light) having a wavelength outside of the operating wavelength band (a noise light). The polychromatic light may be a circularly polarized light having a handedness that is the same as the handedness of the helical structures 117 within the R-PVH element 100. The S/N ratio may be a ratio between the diffraction efficiency of the R-PVH element 100 for the first portion (the signal light) and the diffraction efficiency of the R-PVH element 100 for the second potion (the noise light). When there are multiple noise lights, multiple S/N ratios may be calculated based on the diffraction efficiency of the signal light and respective diffraction efficiency of the noise lights. For simplicity of descriptions, the S/N ratio may be referred to as an S/N ratio of the R-PVH element 100 associated with the backward diffractions of a signal light (e.g., the first portion) and a specific noise light (e.g., the second portion).

For example, when a polychromatic, circularly polarized light having a handedness that is the same as the handedness of the helical structures 117 within the R-PVH element 100, and including a red portion, a green portion, and a blue portion is incident onto the R-PVH element 100 configured with an operating wavelength band corresponding to the green color, two S/N ratios may be calculated for the R-PVH element 100. The first S/N ratio of the R-PVH element 100 may be an S/N ratio when the R-PVH element 100 backwardly diffracts the green portion and the red portion, which may be defined as DE_green/DE_red, where DE_green is the backward diffraction efficiency for the green portion, and DE_red is the backward diffraction efficiency for the red portion. The second S/N ratio of the R-PVH element 100 may be an S/N ratio when the R-PVH element 100 backwardly diffracts the green portion and the blue portion, which may be defined as DE_green/DE_blue, where DE_blue is the backward diffraction efficiency for the blue portion.

Likewise, when the R-PVH element 100 is configured with an operating wavelength band corresponding to the red color, a first S/N ratio (DE_red/DE_green) when the R-PVH element 100 backwardly diffracts the red portion and the green portion, and a second S/N ratio (DE_red/DE_blue) when the R-PVH element 100 backwardly diffracts the red portion and the blue portion may be calculated. When the R-PVH element 100 is configured with an operating wavelength band corresponding to the blue color, a first S/N ratio (DE_blue/DE_green) when the R-PVH element 100 backwardly diffracts the blue portion and the green portion, and a second S/N ratio (DE_blue/DE_red) when the R-PVH element 100 backwardly diffracts the blue portion and the red portion may be calculated.

In some embodiments, the first predetermined value of the diffraction efficiency of the R-PVH element 100 for a circularly polarized light having the wavelength outside of the operating wavelength band may be about 0.08%, 0.07%, 0.06%, 0.05%, 0.04%, 0.03%, 0.02%, or 0.01%. In some embodiments, the second predetermined value for the S/N ratio may be 100, 200, 500, or any other suitable value. For example, the thickness of the R-PVH element 100 may be selected when the backward diffraction efficiency for a circularly polarized light having the wavelength outside of the operating wavelength band is less than the first predetermined value, or when the S/N ratio is greater than 100.

For example, for the polychromatic, circularly polarized light having the handedness that is the same as the handedness of the helical structures 117 within the R-PVH element 100, and including the red portion, the green portion, and the blue portion, the thickness of the R-PVH element 100 configured with the operating wavelength band corresponding to the green color may be selected, configured, or designed when the backward diffraction efficiencies for red portion and the blue portion are both less than the first predetermined value (e.g., 0.05%), or when the first and second S/N ratios are both great than the second predetermined value (e.g., 100). The thickness of the R-PVH element 100 configured with the operating wavelength band corresponding to the red color or the blue color may be similarly determined.

FIG. 1F schematically illustrates diffraction and transmission of the R-PVH element 100 for a polychromatic, circularly polarized light 160, according to an embodiment of the present disclosure. The R-PVH element 100 may be configured with the operating wavelength band, which may not be a broad operating wavelength band covering, e.g., the entire visible wavelength band. Instead, the operating wavelength band may correspond to a color channel within the visible wavelength band (e.g., red, green, or blue color channel). The polychromatic light 160 may include a first portion 160-1 associated with the operating wavelength band and a second portion 160-2 having a wavelength outside of the operating wavelength band. For example, the first portion 160-1 and the second portion 160-2 may correspond to different color channels (e.g., green and red (or blue)) within the visible wavelength band. The circularly polarized light 160 may have a handedness that is the same as the handedness of the helical structures 117 within the R-PVH element 100.

The thickness of the R-PVH element 100 may be specifically configured or designed for reducing the backward diffraction of a circularly polarized light having a wavelength outside of the operating wavelength band (e.g., with the diffraction efficiency being less than 0.08%, 0.07%, 0.06%, 0.05%, 0.04%, 0.03%, 0.02%, or 0.01% or the S/N ratio being greater than 100). As shown in FIG. 1F, the R-PVH element 100 may substantially backwardly diffract the first portion 160-1 associated with the operating wavelength band as a light 162, with a substantially high diffraction efficiency. The R-PVH element 100 may substantially transmit the second portion 160-2 having the wavelength outside of the operating wavelength band as a light 163, with negligible diffraction (e.g., with the diffraction efficiency being less than 0.08%, 0.07%, 0.06%, 0.05%, 0.04%, 0.03%, 0.02%, or 0.01%, or with the S/N ratio being greater than 100).

Thus, for the polychromatic, circularly polarized light 160, the R-PVH element 100 may output two diffracted lights: the diffracted light 162 associated with the operating wavelength band, and a diffracted light having the wavelength outside of the operating wavelength band (which is substantially weak and negligible and, thus, is not shown in FIG. 1F). Thus, the R-PVH element 100 may exhibit no or negligible color crosstalk in the diffracted lights. Accordingly, the R-PVH element 100 may exhibit a significantly high S/N ratio.

For discussion purposes, FIG. 1F shows that the R-PVH element 100 functions as an R-PVH grating having a constant in-plane pitch (e.g., similar to that shown in FIG. 1B). The R-PVH element 100 may be configured with a specifically configured or designed uniform thickness, for reducing the backward diffraction of a circularly polarized light having a wavelength outside of the operating wavelength band (e.g., with the diffraction efficiency being less than 0.08%, 0.07%, 0.06%, 0.05%, 0.04%, 0.03%, 0.02%, or 0.01%, or with the S/N ratio being greater than 100).

In some embodiments, the R-PVH element 100 may function as an R-PVH lens having a spatially varying in-plane pitch (e.g., similar to that shown in FIGS. 1C and 1D). FIG. 1G schematically illustrate an x-y sectional view of the R-PVH element 100 functioning as an R-PVH lens (also referred to as 100 for discussion purpose), according to an embodiment of the present disclosure. As shown in FIG. 1G, the R-PVH lens 100 may have a circular aperture with a radius r. The in-plane orientation pattern of the directors of the LC molecules in the R-PVH lens 100 may be similar to that shown in FIGS. 1C and 1D.

The local thicknesses of the R-PVH lens 100 at different positions associated with different in-plane pitches Λ may be specifically configured or designed to reduce the local backward diffractions for a light (e.g., circularly polarized light) having a wavelength outside of the operating wavelength band, with the local diffraction efficiencies being less than the first predetermined value (e.g., 0.08%, 0.07%, 0.06%, 0.05%, 0.04%, 0.03%, 0.02%, or 0.01%) or with the local S/N ratios being greater than the second predetermined value (e.g., 100). Thus, the entire R-PVH element 100 (e.g., entire R-PVH lens) may be configured to substantially transmit the light (e.g., circularly polarized light) having a wavelength outside of the operating wavelength band, with an overall diffraction efficiency being less than the first predetermined value (e.g., 0.08%, 0.07%, 0.06%, 0.05%, 0.04%, 0.03%, 0.02%, or 0.01%) or with an overall S/N ratio being greater than the second predetermined value (e.g., 100).

In some embodiments, the R-PVH lens 100 may be configured to have a thickness variation in a plurality of opposite radial directions from the lens center 150 to the corresponding opposite lens peripheries 155. For example, as shown in FIG. 1G, the R-PVH lens 100 may include a plurality of concentric zones of increasing radii and associated with decreasing in-plane pitches Λ. For discussion purposes, FIG. 1G shows the concentric zones may include a primary zone 180a that is a central, cylindrical zone, and a plurality of secondary zones 180b, 180c, and 180d that are annular, cylindrical (ring-shaped) zones surrounding the primary zone 180a. Although not shown in FIG. 1G, additional annular, cylindrical zones may be included surrounding the secondary zone 180d.

Referring to FIGS. 1C, 1D, and 1G, the primary zone 180a and the secondary zones 180b, 180c, and 180d may be associated with respective in-plane pitches. In some embodiments, the in-plane pitches of the primary zone 180a and the secondary zones 180b, 180c, and 180d may gradually decrease. In some embodiments, each of the primary zone 180a and the secondary zones 180b, 180c, and 180d may be configured to have a uniform thickness across the corresponding zone, while the thicknesses of the primary zone 180a and the secondary zones 180b, 180c, and 180d may be different from one another. In some embodiments, the thickness of at least one (e.g., each) of the zones 180a, 180b, 180c, or 180d may be specifically configured or designed, such that the local backward diffraction efficiencies of at least one (e.g., each) of the zones 180a, 180b, 180c, or 180d for a circularly polarized light having a wavelength outside of the operating wavelength band may be reduced to be less than the first predetermined value (e.g., 0.08%, 0.07%, 0.06%, 0.05%, 0.04%, 0.03%, 0.02%, or 0.01%), or the local S/N ratios of at least one (e.g., each) of the zones 180a, 180b, 180c, or 180d may be increased to be greater than the second predetermined value (e.g., 100).

In some embodiments, the thickness of each zone may be selected such that the local backward diffraction efficiencies of each zone for at least two circularly polarized lights having wavelengths outside of the operating wavelength band are both less than the first predetermined value, or the first and second local S/N ratios of each zone, which are associated with backward diffraction of a circularly polarized light associated with the operating wavelength band (a signal light) and respective circularly polarized lights having wavelengths outside of the operating wavelength band (noise lights), are both greater than the second predetermined value (e.g., 100). Thus, the entire R-PVH element 100 (e.g., entire R-PVH lens) may be configured to substantially transmit the circularly polarized light having a wavelength outside of the operating wavelength band, with an overall diffraction efficiency being less than the first predetermined value (e.g., 0.08%, 0.07%, 0.06%, 0.05%, 0.04%, 0.03%, 0.02%, or 0.01%) or with an overall S/N ratio being greater than the second predetermined value (e.g., 100).

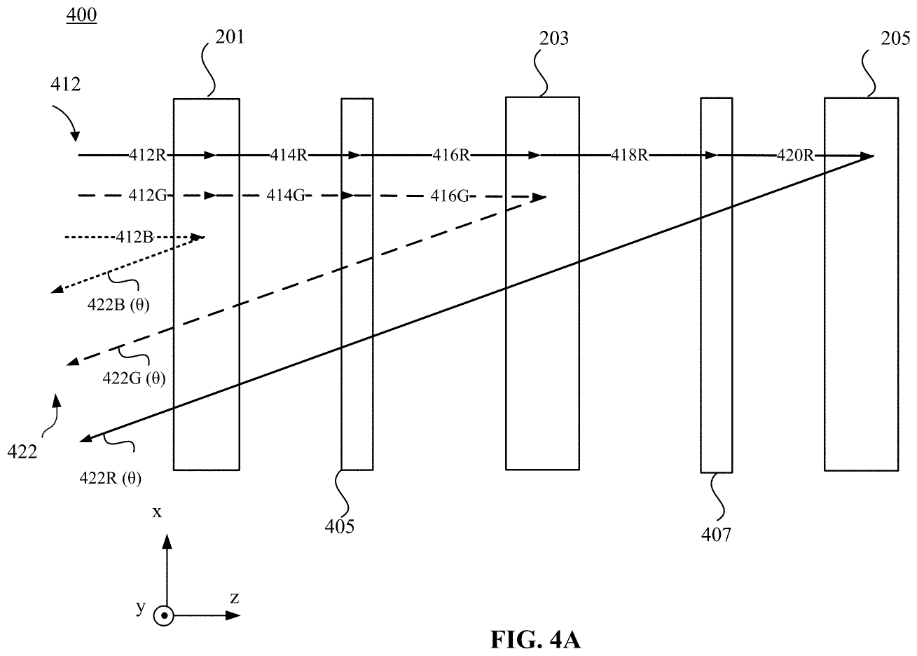

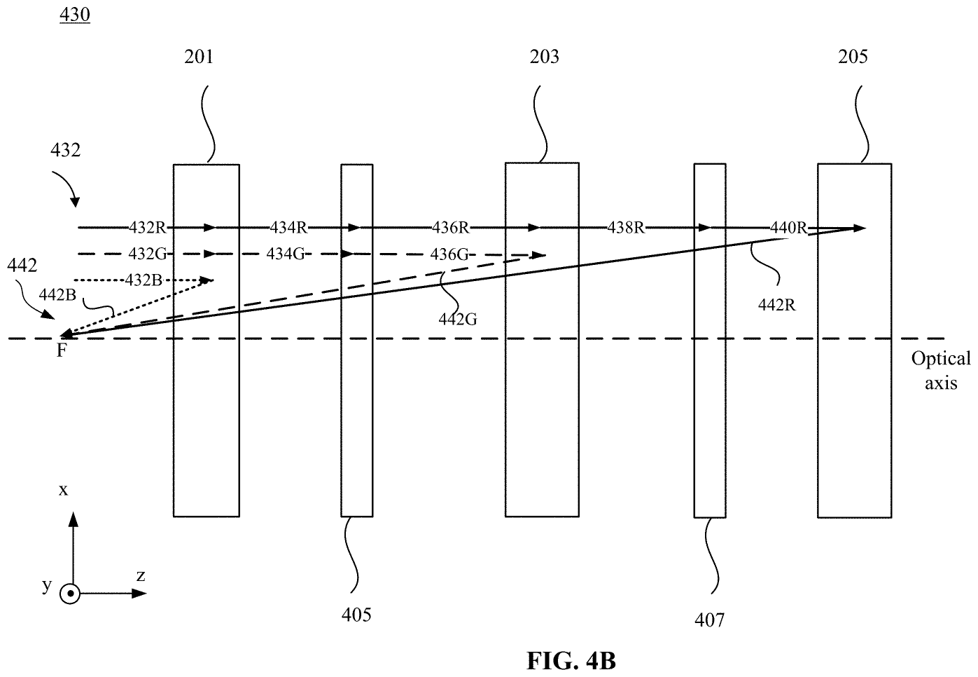

In a conventional R-PVH element with a designed operating wavelength band, the thickness (or local thicknesses) of the conventional R-PVH element may not be specifically configured or designed, to reduce the backward diffraction (or local backward diffractions) for a circularly polarized light having a wavelength outside of the operating wavelength band, such that the diffraction efficiency (or local diffraction efficiencies) is less than the first predetermined value (e.g., 0.08%, 0.07%, 0.06%, 0.05%, 0.04%, 0.03%, 0.02%, or 0.01%), or the S/N ratio (or local S/N rations) is greater than the second predetermined value (e.g., 100). Thus, for a polychromatic, circularly polarized light, the conventional R-PVH element may exhibit a substantially strong color crosstalk and a substantially low S/N ratio. Descriptions of a conventional R-PVH element and an R-PVH element including a plurality of conventional R-PVH elements will be explained in connection with FIGS. 4A-4C.

In the present disclosure, a plurality of R-PVH elements 100, which are configured with different operating wavelength bands and specifically designed thicknesses for reducing the backward diffraction of a circularly polarized light having a wavelength range outside of the corresponding operating wavelength band, may be stacked to form various apochromatic PVH devices. The disclosed apochromatic PVH devices may be configured with reduced color crosstalk, increased S/N ratio, and increased diffraction efficiency. The disclosed apochromatic PVH device may include a plurality of R-PVH elements arranged in an optical series. In some embodiments, the plurality of R-PVH elements may be R-PVH gratings. The disclosed apochromatic PVH device may function as an apochromatic beam deflector configured to deflect (or steer) lights of two or more predetermined wavelength bands in a same deflecting (or steering) angle. In some embodiments, the plurality of R-PVH elements may be R-PVH lenses, e.g., on-axis focusing or off-axis focusing spherical R-PVH lenses, aspherical R-PVH lenses, cylindrical R-PVH lenses, freeform R-PVH lenses, etc. The disclosed apochromatic PVH device may function as an apochromatic PVH lens (e.g., on-axis focusing or off-axis focusing spherical PVH lens, aspherical PVH lens, cylindrical PVH lens, freeform PVH lens, etc.) configured to focus lights of two or more predetermined wavelength bands to a common focus.

In some embodiments, the two or more predetermined wavelength bands may include three predetermined wavelength bands. In some embodiments, the three predetermined wavelength bands may include visible wavelength bands corresponding to multiple, different colors. In some embodiments, the plurality of wavelength bands may include visible wavelength bands, infrared (“IR”) wavelength bands, ultraviolet (“UV”) wavelength bands, or a combination thereof. In some embodiments, the three predetermined wavelength bands may be represented by three predetermined wavelengths. In some embodiments, the three predetermined wavelengths may include visible wavelengths corresponding to multiple colors. In some embodiments, three predetermined wavelengths may include visible wavelengths, infrared wavelengths, ultraviolet wavelengths, or a combination thereof.

In the following descriptions, for illustrative purposes, three visible wavelength bands corresponding to multiple colors or color channels are used. For example, a first wavelength band may correspond to blue color (or color channel), a second wavelength band may correspond to green color (or color channel), and a third wavelength band may correspond to red color (or color channel). Apochromatic PVH devices that include three R-PVH elements and that operate for the visible spectral region are used as examples of the apochromatic PVH devices.

In some embodiments, apochromatic PVH devices may be designed based on three wavelengths: λ_{R}=635 nm, λ_{G}=530 nm, and λ_{B}=450 nm. In such an embodiment, the red color channel may correspond to a wavelength of λ_{R}=635 nm, the green color channel may correspond to a wavelength of λ_{G}=530 nm, and the blue color channel corresponds to a wavelength of λ_{B}=450 nm. In some embodiments, apochromatic PVH devices that operate for any suitable spectral region (e.g., IR spectral region, UV spectral region) and/or that include any suitable number of R-PVH elements may also be configured, following the same design principles for the apochromatic PVH devices described below. For discussion purposes, a predetermined wavelength band may be referred to as a predetermined color channel, a light having a predetermined wavelength band corresponding to a predetermined color (or color channel) may be referred to as a light of a predetermined color channel (or a light of predetermined color). A polychromatic light may include multiple portions of different color channels, and may be also referred to as a light of multiple color channels.

In some embodiments, an array of apochromatic PVH devices (e.g., apochromatic PVH microlens array) may be configured, following the same design principles for the apochromatic PVH devices described below. A stack of apochromatic PVH devices may be configured following the same design principles for the apochromatic PVH devices described below, e.g., a stack of apochromatic PVH beam deflectors configured to deflect a polychromatic light along different axes, a stack of apochromatic PVH lenses configured with ultra-high optical power, etc.

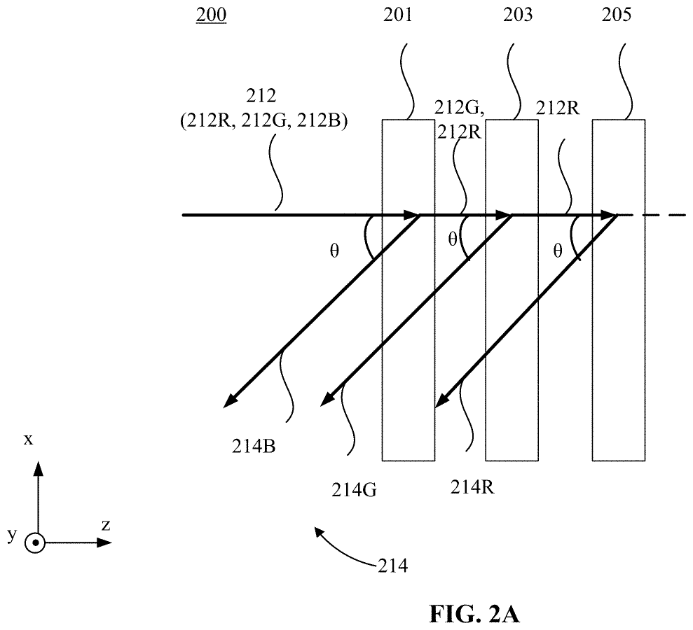

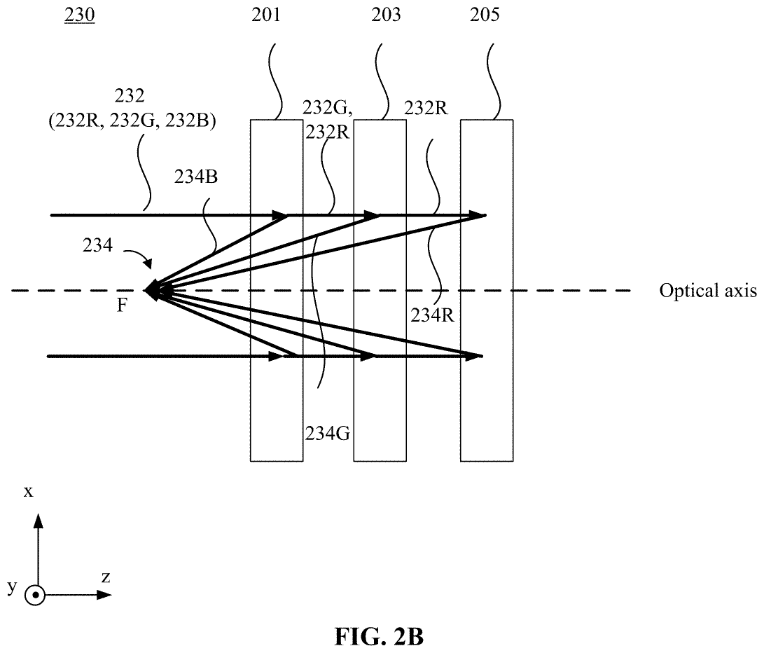

FIG. 2A schematically illustrates an x-z sectional view of an apochromatic PVH device 200, according to an embodiment of the present disclosure. As shown in FIG. 2A, the PVH device 200 may include a plurality of (e.g., three) R-PVH elements 201, 203, and 205 arranged in an optical series. Each of the R-PVH elements 201, 203, and 205 may be an embodiment of the R-PVH element 100 shown in FIGS. 1A-1G. In some embodiments, at least one (e.g., each) of the R-PVH elements 201, 203, or 205 may include a liquid crystal polymer (“LCP”) layer. In some embodiments, the LCP layer may include polymerized (or cross-linked) LCs, polymer-stabilized LCs, photo-reactive LC polymers, or any combination thereof. The LCs may include nematic LCs, twist-bend LCs, chiral nematic LCs, smectic LCs, or any combination thereof.

For discussion purposes, FIG. 2A shows that the R-PVH elements 201, 203, and 205 are spaced apart from one another with a gap. In some embodiments, the R-PVH elements 201, 203, and 205 may be directly coupled to one another without a gap therebetween. In some embodiments, the R-PVH elements 201, 203, and 205 may be directly coupled to one another without another optical element disposed therebetween. In some embodiments, the R-PVH elements 201, 203, and 205 may be indirectly coupled to one another with another optical element (e.g., a compensation plate, etc.) disposed therebetween. In some embodiments, the apochromatic PVH device 200 may function as a lens configured to focus, via diffraction, lights of multiple (e.g., three) color channels (e.g., red, green, and blue color channels) to a single common focus. In some embodiments, the apochromatic PVH device 200 may function as a beam deflector configured to deflect (or steer) lights of the multiple color channels in a single common deflecting (or steering) angle.

In some embodiments, each of the R-PVH elements 201, 203, and 205 may be configured to have a designed operating wavelength range (or band) associated with one of the three color channels. Each of the R-PVH elements 201, 203, and 205 with a corresponding operating wavelength range may be configured to substantially backwardly diffract a circularly polarized light associated with the corresponding operating wavelength range and having a predetermined handedness, and substantially transmit, with negligible diffraction, a circularly polarized light associated with the corresponding operating wavelength range and having a handedness that is opposite to the predetermined handedness.

In some embodiments, the R-PVH elements 201, 203, and 205 may be configured with different polarization selectivities. For example, the R-PVH elements 201, 203, and 205 may include at least one right-handed PVH element and at least one left-handed PVH element. In some embodiments, the R-PVH elements 201, 203, and 205 may be configured with the same polarization selectivity. For example, all of the R-PVH elements 201, 203, and 205 may be right-handed PVH elements or left-handed PVH elements.

For discussion purposes, in the embodiment shown in FIG. 2A, the R-PVH element 201 may have a designed operating wavelength range associated with the blue color channel (referred to as a blue operating wavelength range). The R-PVH element 203 may have a designed operating wavelength range associated with the green color channel (referred to as a green operating wavelength range). The R-PVH element 205 may have a designed (or predetermined) operating wavelength range associated with the red color channel (referred to as a red operating wavelength range). The order of the R-PVH element 201 with the blue operating wavelength range, the R-PVH element 203 with the green operating wavelength range, and the R-PVH element 205 with the red operating wavelength range shown in FIG. 2A is for illustrative purposes. In some embodiments, the R-PVH element 201 with the blue operating wavelength range, the R-PVH element 203 with the green operating wavelength range, and the R-PVH element 205 with the red operating wavelength range may be stacked in any other suitable order.

The thickness (or local thicknesses) of at least one (e.g., each) of the R-PVH elements 201, 203, or 205 with the corresponding operating wavelength band may be specifically configured or designed, such that the backward diffraction efficiency (or local backward diffraction efficiencies) for a circularly polarized light having a wavelength outside of the corresponding operating wavelength band is less than the first predetermined value (e.g., 0.08%, 0.07%, 0.06%, 0.05%, 0.04%, 0.03%, 0.02%, or 0.01%), or the S/N ratio (or local S/N ratios) associated with backward diffraction of a circularly polarized light having a wavelength within the operating wavelength band and a circularly polarized light having a wavelength outside of the operating wavelength band is greater than the second predetermined value (e.g., 100). Through configuring the thickness (or local thicknesses) of at least one (e.g., each) of the R-PVH elements 201, 203, or 205 with the corresponding operating wavelength band, at least one (e.g., each) of the R-PVH elements 201, 203, or 205 may be configured to substantially transmit, with negligible diffraction, the circularly polarized light having the wavelength range outside of the corresponding operating wavelength band.

In some embodiments, the thickness (or local thicknesses) of the R-PVH element 201 with the blue operating wavelength range (e.g., the wavelength λ_{B}) may be specifically configured or designed, such that the backward diffraction efficiency (or local backward diffraction efficiencies) for at least one of a circularly polarized light associated with the green color channel (e.g., the wavelength λ_{G}) (also referred to as a circularly polarized green light) or a circularly polarized light associated with the red color channel (e.g., the wavelength λ_{R}) (also referred to as a circularly polarized red light) is less than the first predetermined value (e.g., 0.08%, 0.07%, 0.06%, 0.05%, 0.04%, 0.03%, 0.02%, or 0.01%), or the S/N ratio (or local S/N ratios) associated with the backward diffractions of a circularly polarized blue light and at least one of the circularly polarized green light or the circularly polarized red light is greater than the second predetermined value (e.g., 100). In other words, the R-PVH element 201 may be configured to substantially transmit, with negligible diffraction, at least one of a circularly polarized light associated with the green color channel or a circularly polarized light associated with the red color channel.

In some embodiments, the thickness (or local thicknesses) of the R-PVH element 203 with the green operating wavelength range (e.g., the wavelength λ_{G}) may be specifically configured or designed, such that the backward diffraction efficiency (or local backward diffraction efficiencies) for at least one of a circularly polarized light associated with the blue color channel (e.g., the wavelength λ_{B}) (also referred to as the circularly polarized blue light) or the circularly polarized red light is less than the first predetermined value (e.g., 0.08%, 0.07%, 0.06%, 0.05%, 0.04%, 0.03%, 0.02%, or 0.01%), or the S/N ratio (or local S/N ratios) associated with the backward diffractions of the circularly polarized green light and at least one of the circularly polarized red light or the circularly polarized blue light is greater than the second predetermined value (e.g., 100). In other words, the R-PVH element 203 may be configured to substantially transmit, with negligible diffraction, at least one of a circularly polarized light associated with the blue color channel or a circularly polarized light associated with the red color channel.

In some embodiments, the thickness (or local thicknesses) of the R-PVH element 205 with the red operating wavelength range (e.g., the wavelength λ_{R}) may be specifically configured or designed, such that the backward diffraction efficiency (or local backward diffraction efficiencies) for at least one of the circularly polarized blue light or the circularly polarized green light is less than the first predetermined value (e.g., 0.08%, 0.07%, 0.06%, 0.05%, 0.04%, 0.03%, 0.02%, or 0.01%), or the S/N ratio (or local S/N ratios) associated with the backward diffractions of the circularly polarized red light and at least one of the circularly polarized blue light or the circularly polarized green light is greater than the second predetermined value (e.g., 100). In other words, the R-PVH element 205 may be configured to substantially transmit, with negligible diffraction, at least one of a circularly polarized light associated with the blue color channel or a circularly polarized light associated with the green color channel.

In the embodiment shown in FIG. 2A, for discussion purposes, the thickness (or local thicknesses) of the R-PVH element 201 with the blue operating wavelength range (e.g., the wavelength λ_{B}) may be specifically configured or designed, such that the backward diffraction (or local backward diffractions) efficiencies for both of the circularly polarized green light and the circularly polarized red light are less than the first predetermined value (e.g., 0.08%, 0.07%, 0.06%, 0.05%, 0.04%, 0.03%, 0.02%, or 0.01%), or the S/N ratios (or local S/N ratios) associated with the backward diffraction of the circularly polarized blue light and each of the circularly polarized red light and the circularly polarized green light are greater than the second predetermined value (e.g., 100). In other words, the R-PVH element 201 may be configured to substantially transmit, with negligible diffraction, both of a circularly polarized light associated with the green color channel and a circularly polarized light associated with the red color channel.

In the embodiment shown in FIG. 2A, for discussion purposes, the thickness (or local thicknesses) of the R-PVH element 203 with the green operating wavelength range (e.g., the wavelength λ₀ may be specifically configured or designed, such that the backward diffraction (or local backward diffractions) efficiencies for both of the circularly polarized blue light and the circularly polarized red light are less than the first predetermined value (e.g., 0.08%, 0.07%, 0.06%, 0.05%, 0.04%, 0.03%, 0.02%, or 0.01%), or the S/N ratios (or local S/N ratios) associated with the backward diffractions of the circularly polarized green light and each of the circularly polarized blue light and the circularly polarized red light are greater than the second predetermined value (e.g., 100). In other words, the R-PVH element 203 may be configured to substantially transmit, with negligible diffraction, both of a circularly polarized light associate with the blue color channel and a circularly polarized light associate with the red color channel.

In the embodiment shown in FIG. 2A, for discussion purposes, the thickness (or local thicknesses) of the R-PVH element 205 with the red operating wavelength range (e.g., the wavelength λ_{R}) may be specifically configured or designed, such that the backward diffraction (or local backward diffractions) efficiencies for both of the circularly polarized blue light and the circularly polarized green light are less than the first predetermined value (e.g., 0.08%, 0.07%, 0.06%, 0.05%, 0.04%, 0.03%, 0.02%, or 0.01%), or the S/N ratios (or local S/N ratios) associated with the backward diffraction of the circularly polarized red light and each of the circularly polarized blue light and the circularly polarized green light are greater than the second predetermined value (e.g., 100). In other words, the R-PVH element 205 may be configured to substantially transmit, with negligible diffraction, both of a circularly polarized light associated with the blue color channel and a circularly polarized light associated with the green color channel.

In the embodiment shown in FIG. 2A, the R-PVH elements 201, 203, and 205 may be R-PVH gratings, which are referred to as a first R-PVH grating 201, a second R-PVH grating 203, and a third R-PVH grating 205 for discussion purposes. The PVH device 200 may function as an apochromatic beam deflector (also referred to as 200 for discussion purposes). Each of the R-PVH elements 201, 203, and 205 may have a uniform thickness, and the R-PVH elements 201, 203, and 205 may have different thicknesses. For example, the thicknesses of at least two of the R-PVH elements 201, 203, and 205 may be different from one another.

In the embodiment shown in FIG. 2A, the R-PVH gratings 201, 203, and 205 are presumed to substantially maintain a polarization of a circularly polarized light, while diffracting or transmitting the circularly polarized light. In the embodiment shown in FIG. 2A, the R-PVH gratings 201, 203, and 205 are presumed to substantially maintain at least one (e.g., all) of the propagation direction and the wavefront of a circularly polarized light, while transmitting the circularly polarized light.

In some embodiments, referring to FIG. 1B, FIG. 1E, and FIG. 2A, the in-plane pitch Pin of the LCPH element 100 functioning as an R-PVH grating (e.g., R-PVH grating 201, 203, or 205) may determine the diffraction angle of a diffracted light. The diffraction angle of a 1^{st} order diffracted light may be calculated based on the following grating equation:

sin(θ_{def})≈λ/(n*Pᵢₙ),

where θ_{def} is the diffraction angle of the 1^{st} order diffracted light, λ is an incidence wavelength, n is the refractive index of the LCPH element 100, and Pᵢₙ is the in-plane pitch of the LCPH element 100. In some embodiments, the refractive index n of the LCPH element 100 may be the average refractive index of the birefringent material (e.g., an LC material) forming the LCPH element 100, where n=(nₑ+nₒ)/2, nₑ and nₒ are the extraordinary and ordinary refractive indices of the birefringent material (e.g., an LC material), respectively.

In order to diffract lights of the three color channels in the same diffraction angle θ, the in-plane pitches and refractive indices of the R-PVH gratings 201, 203, and 205 may be configured to satisfy the following relationship:

sin(θ)=λ_{B}/(n₁*Pᵢₙ₋₁)=λ_{G}/(n₂*Pᵢₙ₋₂)=λ_{R}/(n₃*Pᵢₙ₋₃),

where Pᵢₙ₋₁, Pᵢₙ₋₂, and Pᵢₙ₋₃ are the in-plane pitches of the first R-PVH grating 201, the second PVH 203, and the third R-PVH grating 205, respectively. Parameters n₁, n₂, and n₃ are the refractive indices of the first R-PVH grating 201, the second R-PVH grating 203, and the third R-PVH grating 205, respectively. In some embodiments, the refractive indices n₁, n₂, and n₃ of the first R-PVH grating 201, the second R-PVH grating 203, and the third R-PVH grating 205 may be configured to be substantially the same, e.g., n₁=n₂=n₃=n. To diffract lights of the three color channels in the same diffraction angle θ, the in-plane pitches Pᵢₙ₋₁, Pᵢₙ₋₂, and Pᵢₙ₋₃ of the R-PVH gratings 201, 203, and 205 may be configured to satisfy the following relationship:

sin(θ)*n=λZ_{B}/Pᵢₙ₋₁=λ_{G}/Pᵢₙ₋₂=λ_{R}/Pᵢₙ₋₃,

where n is the same refractive index of the first R-PVH grating 201, the second PVH grating 203, and the third R-PVH grating 205. In other words, the in-plane pitches Pᵢₙ₋₁, Pᵢₙ₋₂, and Pᵢₙ₋₃ of the R-PVH gratings 201, 203, and 205 may be configured to be different from one another. For example, the in-plane pitch Pᵢₙ₋₁ of the first R-PVH grating 201 may be smaller than the in-plane pitch Pᵢₙ₋₂ of the second R-PVH grating 203 and the in-plane pitch Pᵢₙ₋₃ of the third R-PVH grating 205. The in-plane pitch Pᵢₙ₋₂ of the second R-PVH grating 203 may be smaller than the in-plane pitch Pᵢₙ₋₃ of the third R-PVH grating 205.

As shown in FIG. 2A, for discussion purposes, the R-PVH gratings 201, 203, and 205 may have the same polarization selectivity, e.g., being left-handed R-PVH gratings. For discussion purposes, an incident light 212 of the PVH device 200 may be a polychromatic light including a portion 212R of the red color channel (e.g., the wavelength λ_{R}) (referred to as a “red portion 212R”), a portion 212G of the green color channel (e.g., the wavelength λ_{G}) (referred to as a “green portion 212G”), and a portion 212B of the blue color channel (e.g., the wavelength λ_{B}) (referred to as a “blue portion 212B”). For discussion purposes, the light 212 may be an LHCP, polychromatic light. For discussion purposes, the light 212 may be substantially normally incident onto the PVH device 200. In other words, the light 212 may be a substantially on-axis or axis-parallel incident light. For illustrative purposes, the light 212 is shown as being incident onto the PVH device 200 from a side of the first R-PVH grating 201. In some embodiments, the light 212 may be incident onto the PVH device 200 from a side of the third R-PVH grating 205.

The first R-PVH grating 201 with the blue operating wavelength range may substantially backwardly diffract the blue portion 212B of the LHCP light 212 as an LHCP blue light 214B in the target diffraction angle θ (with respect to a normal of a light outputting surface (that is also a light inputting surface) of the first R-PVH grating 201). As the thickness of the first R-PVH grating 201 is specifically configured or designed, the first R-PVH grating 201 may substantially transmit, with negligible diffraction, the green portion 212G and the red portion 212R of the LHCP light 212 toward the second R-PVH grating 203. In the embodiment shown in FIG. 2A, the first R-PVH grating 201 is presumed to substantially maintain at least one (e.g., all) of the propagation directions, the wavefronts, or the polarizations of the green portion 212G and the red portion 212R of the LHCP light 212, while transmitting the green portion 212G and the red portion 212R of the LHCP light 212.

The second R-PVH grating 203 with the green operating wavelength range may substantially backwardly diffract the green portion 212G of the LHCP light 212 as an LHCP green light 214G in the target diffraction angle θ with respect to a normal of a light outputting surface (that is also a light inputting surface) of the second R-PVH grating 203. The LHCP green light 214G may propagate toward the first R-PVH grating 201. The first R-PVH grating 201 with the blue operating wavelength range may substantially transmit, with negligible diffraction, the LHCP green light 214G. In some embodiments, the first R-PVH grating 201 may substantially maintain at least one (e.g., all) of the propagation direction, the wavefront, or the polarization of the LHCP green light 214G.

As the thickness of the second R-PVH grating 203 is specifically configured or designed, the second R-PVH grating 203 may substantially transmit, with negligible diffraction, the red portion 212R of the LHCP light 212 toward the third R-PVH grating 205. In the embodiment shown in FIG. 2A, the second R-PVH grating 203 is presumed to substantially maintain at least one (e.g., all) of the propagation direction, the wavefront, or the polarization of the red portion 212R of the LHCP light 212, while transmitting the red portion 212R.

The third R-PVH grating 205 with the red operating wavelength range may substantially backwardly diffract the red portion 212R of the LHCP light 212 as an LHCP red light 214R in the target diffraction angle θ with respect to a normal of a light outputting surface (that is also a light inputting surface) of the third R-PVH grating 205. The LHCP red light 214R may propagate toward the second R-PVH grating 203 and the first R-PVH grating 201. The second R-PVH grating 203 with the green operating wavelength range may substantially transmit, with negligible diffraction, the LHCP red light 214R toward the first R-PVH grating 201. In some embodiments, the second R-PVH grating 203 may substantially maintain at least one (e.g., all) of the propagation direction, the wavefront, or the polarization of the LHCP red light 214R. The first R-PVH grating 201 with the blue operating wavelength range may substantially transmit, with negligible diffraction, the LHCP red light 214R. In some embodiments, the first R-PVH grating 201 may substantially maintain at least one (e.g., all) of the propagation direction, the wavefront, or the polarization of the LHCP red light 214R.

Thus, the PVH device 200 may respectively backwardly diffract the blue portion 212B, the green portion 212G, and the red portion 212R of the LHCP incident light 212 as the LHCP blue light 214B, the LHCP green light 214G, and the LHCP red light 214R having the common diffraction angle θ, with reduced color crosstalk and increased S/N ratio. In other words, the PVH device 200 may diffract the blue portion 212B, the green portion 212G, and the red portion 212R of the LHCP light 212 in the common diffraction angle θ, with reduced color crosstalk and increased S/N ratio. At an output side of the PVH device 200, the LHCP blue light 214B, the LHCP green light 214G, and the LHCP red light 214R may be combined as a polychromatic LHCP light 214 that is steered (or deflected) in the common steering angle (or deflecting angle) θ with respect to a normal of a light outputting surface (that is also a light inputting surface) of the PVH device 200.

FIG. 2B schematically illustrates an x-z sectional view of an apochromatic PVH device 230, according to an embodiment of the present disclosure. The apochromatic PVH device 230 may include elements that are the same as or similar to those included in the apochromatic PVH device 200 shown in FIG. 2A. Descriptions of the same or similar elements may refer to the above descriptions rendered in connection with FIG. 2A. For example, as shown in FIG. 2B, the apochromatic PVH device 230 may include a plurality of (e.g., three) R-PVH elements 201, 203, and 205 arranged in an optical series. In the embodiment shown in FIG. 2B, the R-PVH elements 201, 203, and 205 may be R-PVH lenses, which are also referred to as a first R-PVH lens 201, a second R-PVH lens 203, and a third R-PVH lens 205 for discussion purposes. The apochromatic PVH device 230 may function as an apochromatic PVH lens (also referred to as 230 for discussion purposes).

In the embodiment shown in FIG. 2B, the R-PVH lenses 201, 203, and 205 are presumed to substantially maintain a polarization of a circularly polarized light, while diffracting or transmitting the circularly polarized light. In the embodiment shown in FIG. 2A, the R-PVH lenses 201, 203, and 205 are presumed to substantially maintain at least one (e.g., all) of the propagation direction and the wavefront of a circularly polarized light, while transmitting the circularly polarized light.

In some embodiments, referring to FIGS. 1C-1D and FIG. 2B, the focal length of the LCPH element 100 functioning as an R-PVH lens (e.g., the R-PVH lens 201, 203, or 205) may be determined, in part, by the pitch Λ of the in-plane orientation pattern of the LCPH element 100 and the size of an aperture of the LCPH element 100. The focal length of the LCPH element 100 functioning as an R-PVH lens may be calculated by the following lens equation:

f=r/(tan(sin⁻¹(λ/Λ))),

where f is the focal length of the R-PVH element 100, r is the radius of the aperture of the LCPH element 100, λ, is an incidence wavelength, Λ is the pitch of the in-plane orientation pattern at the lens periphery (referred to as the in-plane pitch at the lens periphery for discussion purposes) of the LCPH element 100. In some embodiments, the radius r of the aperture of the LCPH element 100 may be a distance from the lens center 150 to the lens periphery 155 shown in FIGS. 1C and 1D.

In order to focus, via backward diffraction, lights of the three color channels to the common focal point F, the radii r of the apertures and the in-plane pitches Λ at the lens peripheries of the R-PVH lenses 201, 203, and 205 may be configured to satisfy the following relationship:

f=r₁/(tan(sin⁻¹(λ_{B}/Λ₁)))=r₂/(tan(sin⁻¹(λ_{G}/Λ₂)))=r₃/(tan(sin⁻¹(λ_{R}/Λ₃))),

where r₁, r₂, and r₃ are the radii of the apertures of the first R-PVH lens 201, the second R-PVH lens 203, and the third R-PVH lens 205, respectively. Λ₁, Λ₂, and Λ₃ are the in-plane pitches at the lens peripheries of the first R-PVH lens 201, the second R-PVH lens 203, and the third R-PVH lens 205, respectively. f is a design focal length of the apochromatic PVH device 230. In some embodiments, the radii r₁, r₂, and r₃ of the apertures of the first R-PVH lens 201, the second R-PVH lens 203, and the third R-PVH lens 205 may be configured to be substantially the same. To focus the lights of the three wavelengths to the common focal point F, the in-plane pitches Λ₁, Λ₂, and Λ₃ at the lens peripheries of the R-PVH lenses 201, 203, and 205 may be configured to satisfy the following relationship:

r/f=tan(sin⁻¹(λ_{B}/Λ₁))=tan(sin⁻¹(λ_{G}/Λ₂))=tan(sin⁻¹(λ_{R}/Λ₃)),

where r is the radius of the aperture of the first R-PVH lens 201, the second R-PVH lens 203, and the third R-PVH lens 205.

In other words, the in-plane pitches Λ at the lens peripheries of the first R-PVH lens 201, the second R-PVH lens 203, and the third R-PVH lens 205 may be configured to be different from one another. For example, the in-plane pitch Λ₁ at the lens periphery of the first R-PVH lens 201 may be smaller than the in-plane pitch Λ₂ at the lens periphery of the second R-PVH lens 203 and the in-plane pitch Λ₃ at the lens periphery of the third R-PVH lens 205. The in-plane pitch Λ₂ at the lens periphery of the second R-PVH lens 203 may be smaller than the in-plane pitch Λ₃ at the lens periphery of the third R-PVH lens 205.

Referring back to FIG. 2B, for discussion purposes, the R-PVH lenses 201, 203, and 205 may have the same polarization selectivity, e.g., being left-handed PVH lenses. For discussion purposes, an incident light 232 of the PVH device 230 may be a polychromatic light including a portion 232R of red color channel (e.g., the wavelength λ_{R}) (referred to as a red portion 232R), a portion 232G of green color channel (e.g., the wavelength λ_{G}) (referred to as a green portion 232G), and a portion 232B of blue color channel (e.g., the wavelength λ_{B}) (referred to as a blue portion 232B). For discussion purposes, the light 232 may be an LHCP polychromatic light. For discussion purposes, the light 232 may be substantially normally incident onto the PVH device 230. In other words, the light 232 may be a substantially on-axis or axis-parallel incident light. For illustrative purposes, the light 232 is shown as being incident onto the PVH device 230 from a side of the first R-PVH lens 201. In some embodiments, the light 232 may be incident onto the PVH device 230 from a side of the third R-PVH lens 205.

In the embodiment shown in FIG. 2B, the first R-PVH lens 201 with the blue operating wavelength range may substantially backwardly diffract the blue portion 232B of the LHCP light 232 as an LHCP blue light 234B that is focused to a target focal point F. In other words, the first R-PVH lens 201 may focus, via backward diffraction, the blue portion 232B of the LHCP light 232 to the target focal point F. As the local thicknesses of the first R-PVH lens 201 are configured, the first R-PVH lens 201 may substantially transmit, with negligible diffraction, the green portion 232G and the red portion 232R of the LHCP light 232 toward the second R-PVH lens 203. In the embodiment shown in FIG. 2B, the first R-PVH lens 201 is presumed to substantially maintain at least one (e.g., all) of the propagation directions, the wavefronts, or the polarizations of the green portion 232G and the red portion 232R of the LHCP light 232, while transmitting the green portion 232G and the red portion 232R of the LHCP light 232.

The second R-PVH grating 203 with the green operating wavelength range may substantially backwardly diffract the green portion 232G of the LHCP light 232 as an LHCP green light 234G that is focused to the target focal point F. In other words, the second R-PVH lens 203 may focus, via backward diffraction, the green portion 232G of the LHCP light 232 to the target focal point F. The first R-PVH lens 201 with the blue operating wavelength range may substantially transmit, with negligible diffraction, the LHCP green light 234G. In some embodiments, the first R-PVH lens 201 may substantially maintain at least one (e.g., all) of the propagation direction, the wavefront, or the polarization of the LHCP green light 234G.

As the local thicknesses of the second R-PVH lens 203 are configured, the second R-PVH lens 203 may substantially transmit, with negligible diffraction, the red portion 232R of the LHCP light 232 toward the third R-PVH lens 205. In the embodiment shown in FIG. 2B, the second R-PVH lens 203 is presumed to substantially maintain at least one (e.g., all) of the propagation direction, the wavefront, or the polarization of the red portion 232R of the LHCP light 232, while transmitting the red portion 232R.

The third R-PVH lens 205 with the red operating wavelength range may substantially backwardly diffract the red portion 232R of the LHCP light 232 as an LHCP red light 234R that is focused to the target focal point F. In other words, the third R-PVH lens 205 may focus, via backward diffraction, the red portion 232R of the LHCP light 232 to the target focal point F. The LHCP red light 234R may propagate toward the second R-PVH lens 203 and the first R-PVH lens 201. The second R-PVH lens 203 with the green operating wavelength range may substantially transmit, with negligible diffraction, the LHCP red light 234R toward the first R-PVH lens 201. In some embodiments, the second R-PVH lens 203 may substantially maintain at least one (e.g., all) of the propagation direction, the wavefront, or the polarization of the LHCP red light 234R. The first R-PVH grating 201 with the blue operating wavelength range may substantially transmit, with negligible diffraction, the LHCP red light 234R. In some embodiments, the first R-PVH lens 201 may substantially maintain at least one (e.g., all) of the propagation direction, the wavefront, or the polarization of the LHCP red light 234R.

Thus, the PVH device 230 may respectively diffract the blue portion 232B, the green portion 232G, and the red portion 232R of the LHCP light 232 as the LHCP blue light 234B, the LHCP green light 234G, and the LHCP red light 234R that are focused to the common focal point F, with reduced color crosstalk and increased S/N ratio. In other words, the PVH device 230 may focus the polychromatic, LHCP light 232 to the common focal point, with reduced color crosstalk and increased S/N ratio F. At an output side of the PVH device 230, the LHCP blue light 234B, the LHCP green light 234G, and the LHCP red light 234R may form a polychromatic LHCP light 234 that is focused to the common focal point F.

Referring to FIGS. 2A and 2B, according to the order of receiving the incident polychromatic light 212 or 232, the R-PVH elements 201, 203 and 205 may be referred to as a first R-PVH element 201 with a first operating wavelength band, a second R-PVH element 203 with a second operating wavelength band, and a third R-PVH element 205 with a third operating wavelength band. Among the R-PVH elements 201, 203 and 205, the first R-PVH element 201 may be the first element to receive the incident polychromatic light 212 or 232, the second R-PVH element 203 may be the second element to receive the incident polychromatic light 212 or 232, and the third R-PVH element 205 may be the third element (or the last element) to receive the incident polychromatic light 212 or 232.

In some embodiments, the thickness (or local thicknesses) of the first R-PVH element 201 with the first operating wavelength band may be specifically configured or designed, such that the backward diffraction (or local backward diffractions) efficiencies for both of a circularly polarized light associated with the second operating wavelength band (a noise light) and a circularly polarized light associated with the third operating wavelength band (a noise light) are less than the first predetermined value (e.g., 0.08%, 0.07%, 0.06%, 0.05%, 0.04%, 0.03%, 0.02%, or 0.01%), or the S/N ratios (or local S/N ratios) associated with the backward diffractions of a signal light and each of the two noise lights are greater than the second predetermined value (e.g., 100). In other words, the first R-PVH element 201 may be configured to substantially transmit, with negligible diffraction, both of a circularly polarized light associated with the second operating wavelength band and a circularly polarized light associated with the third operating wavelength band.

In some embodiments, the thickness (or local thicknesses) of the second R-PVH element 203 with the second operating wavelength band may be specifically configured or designed, such that the backward diffraction (or local backward diffractions) efficiencies for a circularly polarized light associated with the third operating wavelength band (a noise light) is less than the first predetermined value (e.g., 0.08%, 0.07%, 0.06%, 0.05%, 0.04%, 0.03%, 0.02%, or 0.01%), or the S/N ratio (or local S/N ratios) associated with the backward diffractions of a signal light and the noise light is greater than the second predetermined value (e.g., 100). In other words, the R-PVH element 203 may be configured to substantially transmit, with negligible diffraction, a circularly polarized light associated with the operating wavelength band of the third R-PVH element 205.

In some embodiments, when the thicknesses of the first and second R-PVH elements 201 and 203 have been configured based on the above-described principles, there may not be noise lights (e.g., blue and green lights) incident onto the third R-PVH element 205. Thus, in some embodiments, the thickness (or local thicknesses) of the third R-PVH element 205 with the third operating wavelength band may not need be configured or designed, such that the backward diffraction efficiency (or local backward diffraction efficiencies) for at least one of a circularly polarized light associated with the operating wavelength band of the first R-PVH element 201 or a circularly polarized light associated with the operating wavelength band of the second R-PVH element 203 is less than the first predetermined value, or such that the S/N ratio associated with the backward diffractions of a signal light and at least one of the noise lights is greater than the second predetermined value, as described above.

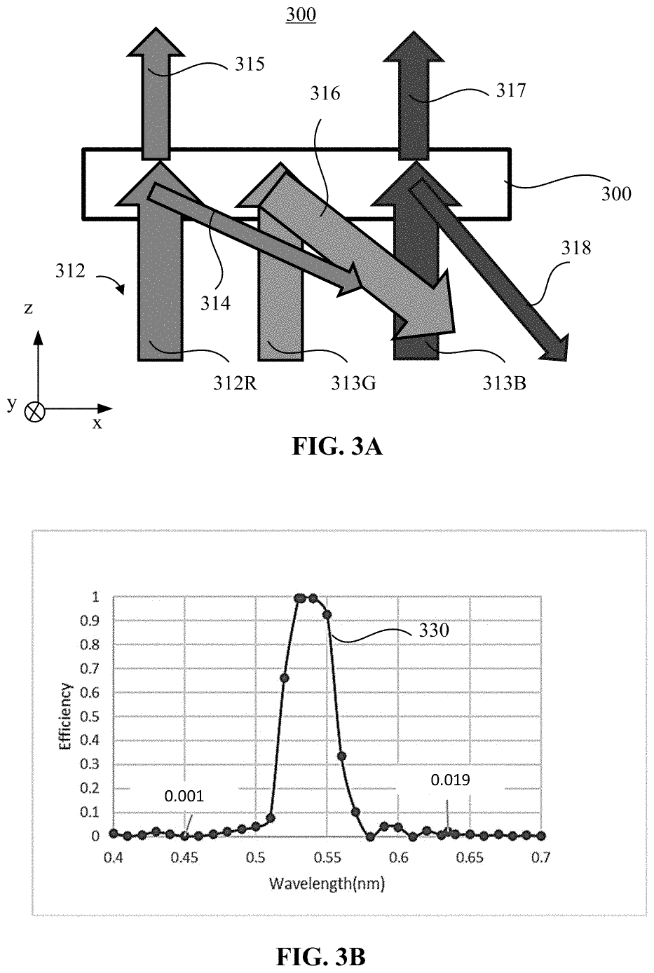

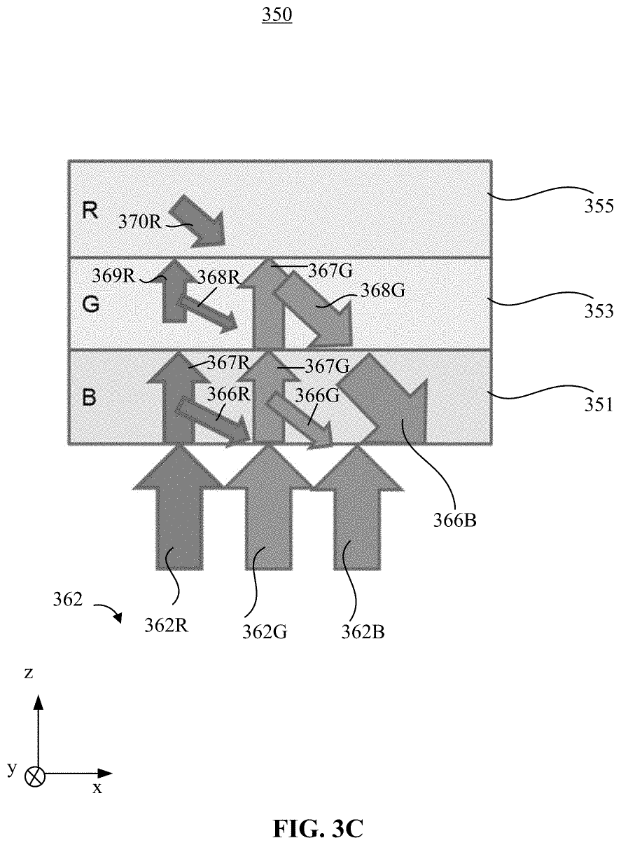

FIG. 3A schematically illustrates diffraction and transmission of a conventional R-PVH element 300 for a polychromatic, circularly polarized light 312. For discussion purposes, the conventional R-PVH element 300 is an R-PVH grating (also referred to as 300). FIG. 3B schematically illustrates a diagram showing a relationship between a diffraction efficiency and a wavelength of an incident light of the conventional R-PVH element 300 shown in FIG. 3A. As shown in FIG. 3B, the horizontal axis is the wavelength (unit: nm) of an incident light of the conventional R-PVH grating 300, and the vertical axis is the backward diffraction efficiency of the conventional R-PVH grating 300. Curve 330 shows a relationship between the diffraction efficiency of the conventional R-PVH grating 300 and the wavelength of an incident light of the R-PVH grating 300.

In some embodiments, the conventional R-PVH grating 300 may be a left-handed R-PVH grating with the green operating wavelength range. The diffraction efficiency of the conventional R-PVH grating 300 for at least one of a circularly polarized light associated with the red operating wavelength band (or circularly polarized red light) or a circularly polarized light associated with the blue operating wavelength band (or circularly polarized blue light) may be greater than the first predetermined value (e.g., 0.08%, 0.07%, 0.06%, 0.05%, 0.04%, 0.03%, 0.02%, or 0.01%), or the S/N ratio associated with the backward diffractions of the circularly polarized green light and at least one of the circularly polarized red light or the circularly polarized blue light may be less than the second predetermined value (e.g., 100). The thickness of the conventional R-PVH grating 300 is not specifically configured or designed based on the disclosed principle.

As shown in FIG. 3A, an incident light 312 of the R-PVH grating 300 may be a polychromatic light including a red portion 312R (e.g., wavelength is 635 nm), a green portion 312G (e.g., wavelength is about 530 nm), and a blue portion 312B (e.g., wavelength is 450 nm). The light 312 may be an LHCP, polychromatic light. Referring to FIGS. 3A and 3B, the conventional R-PVH grating 300 may substantially backwardly diffract the green portion 312G of the light 312 to a green light 316, with a substantially high diffraction efficiency, e.g., about 100% as shown in the curve 330. Thus, the transmission of the conventional R-PVH grating 300 for the LHCP green light 302 may be substantially 0. The conventional R-PVH grating 300 may partially backwardly diffract the red portion 312R of the light 312 as a red light 314 with a diffraction efficiency of about 0.1% (or 0.001) as shown at the wavelength=450 nm in the curve 330, and partially transmit the red portion 312R of the light 312 as a red light 315 with a transmittance of about 99.9%. In addition, the conventional R-PVH grating 300 may partially backwardly diffract the blue portion 312B of the light 312 as a blue light 318 with a diffraction efficiency of about 1.9% (or 0.019) as shown at the wavelength=635 nm in the curve 330, and partially transmit blue portion 312B of the light 312 as a blue light 317 with a transmittance of about 98%.

Referring to FIG. 3A, as the diffraction angle of the conventional R-PVH grating 300 is wavelength dependent, the red light 314, the green light 316, and the blue light 318 that are backwardly diffracted by the conventional R-PVH grating 300 may have different diffraction angles. For example, as shown in FIG. 3A, the diffraction angle of the red light 314 may be greater than the diffraction angle of the green light 316 and the diffraction angle of the blue light 318, and the diffraction angle of the green light 316 may be greater than the diffraction angle of the blue light 318. An overall diffracted light (including the red light 314, the green light 316, and the blue light 318) of the conventional R-PVH grating 300 for a polychromatic light may exhibit a strong color aberration.

When the designed operating wavelength range of the conventional R-PVH grating 300 is a red (or blue) wavelength range, the conventional R-PVH grating 300 may also backwardly diffract the red, green, and blue portions of a polychromatic light in different diffraction angles, resulting in a strong color crosstalk and a low S/N ratio. Accordingly, an overall diffracted light of the conventional R-PVH grating 300 for a polychromatic light may exhibit a strong color aberration.

Comparing the disclosed R-PVH element 100 shown in FIG. 1F with the thickness specifically configured or designed based on the disclosed principle, and the conventional R-PVH grating 300 shown in FIG. 3A, an overall diffracted light of the conventional R-PVH grating 300 for a polychromatic light may exhibit a relatively strong color aberration. When a plurality of the conventional R-PVH gratings 300 configured with different operating wavelength ranges are stacked to form a conventional PVH device, the conventional PVH device may have a strong color crosstalk and a low S/N ratio when diffracting a polychromatic light.

FIG. 3C schematically illustrates an x-z sectional view of a conventional PVH device 350 including a stack of three conventional R-PVH elements 351, 353, and 355. The conventional R-PVH elements 351, 353, and 355 may be conventional R-PVH gratings similar to the conventional R-PVH grating 300 shown in FIG. 3A. The conventional R-PVH gratings 351, 353, and 355 may have the blue operating wavelength range, the green operating wavelength range, and the red operating wavelength range, respectively.

The thickness of the conventional R-PVH grating 351 with the red operating wavelength range is not specifically configured or designed based on the disclosed principle. The diffraction efficiency of the conventional R-PVH grating 351 for at least one of a circularly polarized light associated with the green operating wavelength band or a circularly polarized light associated with the blue operating wavelength band may be greater than the first predetermined value (e.g., 0.08%, 0.07%, 0.06%, 0.05%, 0.04%, 0.03%, 0.02%, or 0.01%), or the S/N ratio (or local S/N ratios) for lights of the red operating wavelength range may be less than the second predetermined value (e.g., 100).

The thickness of the conventional R-PVH grating 353 with the green operating wavelength range is not specifically configured or designed based on the disclosed principle. The diffraction efficiency of the conventional R-PVH grating 353 for at least one of a circularly polarized light associated with the red operating wavelength band or a circularly polarized light associated with the blue operating wavelength band may be greater than the first predetermined value (e.g., 0.08%, 0.07%, 0.06%, 0.05%, 0.04%, 0.03%, 0.02%, or 0.01%), or the S/N ratio (or local S/N ratios) for lights of the green operating wavelength range may be less than the second predetermined value (e.g., 100).

The thickness of the conventional R-PVH grating 355 with the blue operating wavelength range is not specifically configured or designed based on the disclosed principle. The diffraction efficiency of the conventional R-PVH grating 355 for at least one of a circularly polarized light associated with the red operating wavelength band or a circularly polarized light associated with the green operating wavelength band may be greater than the first predetermined value (e.g., 0.08%, 0.07%, 0.06%, 0.05%, 0.04%, 0.03%, 0.02%, or 0.01%), or the S/N ratio (or local S/N ratios) for lights of the blue operating wavelength range may be less than the second predetermined value (e.g., 100).

As shown in FIG. 3C, an incident light 362 of the conventional PVH device 350 may be a polychromatic light including a red portion 362R, a green portion 362G, and a blue portion 362B. The light 362 may be an LHCP, polychromatic light, which is substantially normally incident onto the PVH device 350. The R-PVH gratings 351, 353, and 355 may be left-handed R-PVH gratings. The R-PVH grating 351 with the blue operating wavelength range may substantially backwardly diffract the blue portion 362B of the LHCP light 362 as an LHCP blue light 366B in a target diffraction angle θ′. The R-PVH grating 351 may partially backwardly diffract the red portion 362R of the LHCP light 362 as an LHCP red light 366R, and partially transmit the red portion 362R of the LHCP light 362 as an LHCP red light 367R. In addition, the R-PVH grating 351 may partially backwardly diffract the green portion 362G of the LHCP light 362 as an LHCP green light 366G, and partially transmit the green portion 362G of the LHCP light 362 as an LHCP green light 367G.

As the diffraction angle of the R-PVH grating 351 is wavelength dependent, the LHCP red light 366R, the LHCP green light 366G, and the LHCP blue light 366B that are backwardly diffracted by the R-PVH grating 351 may have different diffraction angles, resulting in a color crosstalk in the diffracted lights 366R, 366G, and 366B. For example, the diffraction angles of the LHCP red light 366R and the LHCP green light 366G may be greater than the target diffraction angle θ′, and the diffraction angle of the LHCP red light 366R may be greater than the diffraction angle of the LHCP green light 366G.

The LHCP red light 367R and the LHCP green light 367G may propagate toward the R-PVH grating 353. The R-PVH grating 353 with the green operating wavelength range may substantially backwardly diffract the LHCP green light 367G as an LHCP green light 368G in the target diffraction angle θ′. The R-PVH grating 353 may partially backwardly diffract the LHCP red light 367R as an LHCP red light 368R, and partially transmit the LHCP red light 367R as an LHCP red light 369R. As the diffraction angle of the R-PVH grating 353 is wavelength dependent, the LHCP red light 368R and the LHCP green light 368G that are backwardly diffracted by the R-PVH grating 353 may have different diffraction angles, resulting in a color crosstalk in the diffracted lights 368R and 368G. For example, the diffraction angles of the LHCP red light 368R may be greater than the diffraction angle of the LHCP green light 368G (i.e., the target diffraction angle θ′).

The LHCP red light 369R may propagate toward the R-PVH grating 355. The R-PVH grating 355 with the red operating wavelength range may substantially backwardly diffract the LHCP red light 369R as an LHCP red light 370R in the target diffraction angle θ′.

The conventional PVH device 350 may deflect the polychromatic light 362 including the red, blue, and green portions with a large color crosstalk and a low S/N ratio. The conventional PVH device 350 shown in FIG. 3C may not function as an apochromatic beam deflector.

FIG. 4A schematically illustrates an x-z sectional view of an apochromatic PVH device 400, according to an embodiment of the present disclosure. The apochromatic PVH device 400 may include elements that are the same as or similar to those included in the apochromatic PVH device 200 shown in FIG. 2A, or the apochromatic PVH device 230 shown in FIG. 2B. Descriptions of the same or similar elements may refer to the above descriptions rendered in connection with FIG. 2A, or FIG. 2B.

As shown in FIG. 4A, the PVH device 400 may include a plurality of (e.g., three) R-PVH elements 201, 203, and 205, and a plurality of compensation plates 405 and 407 alternately arranged with the R-PVH elements 201, 203, and 205. A compensation plate 405 or 407 may be disposed between two neighboring PVH elements 201, 203, and 205. In some embodiments, the compensation plate 405 or 407 may be disposed adjacent and aligned with a corresponding R-PVH element 201, 203, or 205. The compensation plate 405 or 407 may be disposed before the corresponding R-PVH element 201, 203, or 205 in a propagating direction of an input light. The compensation plate 405 or 407 may be configured to control a polarization of the input light, such that the light output from the compensation plate toward the corresponding R-PVH element may have a predetermined (or desirable) polarization. The apochromatic PVH device 400 may include any other suitable number of compensation plates, such as one, three, or four, etc.

For discussion purposes, FIG. 4A shows that the R-PVH elements 201, 203, and 205, and the compensation plates 405 and 407 are spaced apart from one another with a gap. In some embodiments, the R-PVH elements 201, 203, and 205, and the compensation plates 405 and 407 may be directly coupled to one another without a gap therebetween. In some embodiments, the R-PVH elements 201, 203, and 205, and the compensation plates 405 and 407 may be directly coupled to one another without another optical element disposed therebetween. In some embodiments, the R-PVH elements 201, 203, and 205, and the compensation plates 405 and 407 may be indirectly coupled to one another with another optical element disposed therebetween.

In the embodiment shown in FIG. 4A, the thickness (or local thicknesses) of at least one (e.g., each) of the R-PVH elements 201, 203, or 205 with the corresponding operating wavelength band may be specifically configured or designed, such that the backward diffraction efficiency (or local backward diffraction efficiencies) for a circularly polarized light having a wavelength outside of the corresponding operating wavelength band is less than the first predetermined value (e.g., 0.08%, 0.07%, 0.06%, 0.05%, 0.04%, 0.03%, 0.02%, or 0.01%), or the S/N ratio (or local S/N ratios) associated with backward diffraction of the circularly polarized light having the wavelength outside of the corresponding operating wavelength band is greater than the second predetermined value (e.g., 100). In other words, at least one (e.g., each) of the R-PVH elements 201, 203, or 205 may be configured to substantially transmit, with negligible diffraction, the circularly polarized light having the wavelength range outside of the corresponding operating wavelength band.

For example, the thickness of the first R-PVH element 201 with a blue operating wavelength band may be selected, such that both of the S/N ratio associated with the backward diffractions of the circularly polarized blue light and the circularly polarized green light and the S/N ratio associated with the backward diffractions of the circularly polarized blue light and the circularly polarized red light are greater than the second predetermined value (e.g., 100). The thickness of the second R-PVH element 203 with a green operating wavelength band may be selected, such that both of the S/N ratio associated with the backward diffractions of the circularly polarized green light and the circularly polarized blue light, and the S/N ratio associated with the backward diffractions of the circularly polarized green light and the circularly polarized red light are greater than the second predetermined value (e.g., 100). The thickness of the third R-PVH element 205 with a red operating wavelength band may be selected, such that both of the S/N ratio associated with the backward diffractions of the circularly polarized red light and the circularly polarized green light and the S/N ratio associated with the backward diffractions of the circularly polarized red light and the circularly polarized blue light are greater than the second predetermined value (e.g., 100).

In the embodiment shown in FIG. 4A, due to the waveplate effect of the R-PVH element 201, 203, or 205, the R-PVH element 201, 203, or 205 may provide an undesirable (or excess) phase retardance to a circularly polarized input light having a wavelength outside of the corresponding operating wavelength range, while transmitting the circularly polarized input light. In some embodiments, due to the excess phase retardance, the R-PVH element 201, 203, or 205 may not maintain a polarization of the circularly polarized input light, while transmitting the circularly polarized input light. Instead, the R-PVH element 201, 203, or 205 may change the polarization of a transmitted light (or a non-diffracted light) having the wavelength outside of the corresponding operating wavelength range. For example, the transmitted light may be a polarized light including both of an RHCP component and an LHCP component (e.g., an elliptically polarized light), rather than a circularly polarized light having the same handedness as that of the circularly polarized input light. Such a polarization change of the transmitted light may be referred to as a polarization deviation of the transmitted light.

For discussion purposes, the light transmitted by a preceding R-PVH element 201, 203, or 205 is also referred to as a light output from a preceding R-PVH element 201, 203, or 205. When such a depolarized light output from a preceding R-PVH element 201, 203, or 205 is directly incident onto a subsequent R-PVH element 201, 203, or 205, and the wavelength of the depolarized light is within the operating wavelength range of the subsequent R-PVH element 201, 203, or 205, due to the circular polarization selectivity of the subsequent R-PVH element 201, 203, or 205, the subsequent R-PVH element 201, 203, or 205 may backwardly diffract the RHCP (or LHCP) component of the depolarized light, and transmit the LHCP (or RHCP) component of the depolarized light. As a result, the diffraction efficiency of the subsequent R-PVH element 201, 203, or 205 in a target diffract direction may be reduced.

In the disclosed embodiments, the compensation plate 405 or 407 disposed between the preceding R-PVH element 201, 203, or 205 and the subsequent R-PVH element 201, 203, or 205 may control the polarization state of a light after the light is output from the preceding R-PVH element 201, 203, or 205 and before the light is incident onto the subsequent R-PVH element 201, 203, or 205. In some embodiments, the compensation plate 405 or 407 may be configured with a compensating phase retardance that at least partially (e.g., completely) cancels out the excess phase retardance provided to the circularly polarized input light transmitted through the preceding R-PVH element 201, 203, or 205. Thus, the compensation plate 405 or 407 may compensate for the polarization deviation of the transmitted light of (or the light output from) the preceding R-PVH element 201, 203, or 205. For example, the light output from the preceding R-PVH element 201, 203, or 205 may have a polarization state (e.g., a non-circular polarization) other than a predetermined circular polarization. The compensation plate 405 or 407 may convert the polarization state of the light output from the preceding R-PVH element 201, 203, or 205 from the non-circular polarization to the predetermined circular polarization, while transmitting the light.

Thus, when the light with the adjusted polarization (e.g., the predetermined circular polarization) is incident onto a subsequent R-PVH element 201, 203, or 205, and when the wavelength of the light with the adjusted polarization is within the operating wavelength range of the subsequent R-PVH element 201, 203, or 205, the subsequent R-PVH element 201, 203, or 205 may substantially backwardly diffract the light with the adjusted polarization in the target diffract direction. Through configuring the compensation plate 405 or 407 to compensate for the polarization deviation of the light transmitted through the preceding R-PVH element 201, 203, or 205, the diffraction efficiency of the subsequent R-PVH element 201, 203, or 205 in the target diffract direction may be increased.

In some embodiments, a circularly polarized light associated with the corresponding operating wavelength range of a subsequent R-PVH element may propagate through a plurality of preceding R-PVH elements before that light is incident onto the subsequent R-PVH element. In such an embodiment, the compensation plate 405 or 407 disposed between the last one of the plurality of preceding R-PVH elements and the subsequent R-PVH element may be configured with a compensating phase retardance that at least partially (e.g., completely) cancels out the excess phase retardance provided to the circularly polarized input light transmitted through the plurality of preceding R-PVH elements (and any other compensation plate that may be disposed between the preceding R-PVH elements). The compensation plate 405 or 407 disposed between the last one of the plurality of preceding R-PVH elements and the subsequent R-PVH element may be configured to compensate for the polarization deviation of the transmitted light of (or the light output from) the plurality of preceding R-PVH elements (and any other compensation plate that may be disposed between the preceding R-PVH elements).

For example, the light output from the plurality of preceding R-PVH elements (and any other compensation plate that may be disposed between the preceding R-PVH elements) may have a polarization state (e.g., a non-circular polarization) other than a predetermined circular polarization. The compensation plate 405 or 407 disposed between the last one of the plurality of preceding R-PVH elements and the subsequent R-PVH element may convert the polarization state of the light output from the plurality of preceding R-PVH elements (and any other compensation plate that may be disposed between the preceding R-PVH elements) from the non-circular polarization to the predetermined circular polarization, while transmitting the light.

In some embodiments, the compensation plate 405 or 407 may include an A-plate or A-film. In some embodiments, the compensation plate 405 or 407 may include a positive A-plate. A positive A-plate may be a retardation plate with nₓ>n_{y}=n_{z}, where nₓ and n_{y} are principal refractive indices in orthogonal directions at a plate plane (e.g., an x-y plane in FIG. 4A), and n_{z} is a principal refractive index in an out-of-plane vertical direction (e.g., a z-axis direction in FIG. 4A), which is also referred to as the refractive index in the plate thickness direction. A negative A-plate may be a retardation plate with nₓ<n_{y}=n_{z}. The in-plane retardance of the positive A-plate may be determined by the difference between two refractive indices in the plate plane, and the thickness of the plate, according to the following relationship:

Rᵢₙ=d×(nₓ−n_{y}),

wherein d is the thickness of the A-plate, and Δn_{xy}=nₓ−n_{y} is the in-plane birefringence of the A-plate. In some embodiments, the compensation plate 405 or 407 may include a positive A-plate. In some embodiments, the positive A-plate may have an optical axis aligned parallel to the plane of the plate (e.g., the x-y plane in FIG. 4A).

In the embodiment shown in FIG. 4A, the compensation plates 405 may be referred to as a first compensation plate 405, which may be disposed between the first R-PVH element 201 and the second R-PVH element 203. The first compensation plate 405 may be configured to control a polarization of a light after the light is output from the first R-PVH element 201 before the light is incident onto the second R-PVH element 203. The light may be associated with the operating wavelength range of the second R-PVH element 203. The light output from the first R-PVH element 201 may be a depolarized light, e.g., having a non-circular polarization, due to the excess phase retardance introduced by the first R-PVH element 201. The first compensation plate 405 may be configured to compensate for the polarization deviation of the light output from the first R-PVH element 201. The first compensation plate 405 may convert the polarization state of the light output from the first R-PVH element 201 from the non-circular polarization to a predetermined circular polarization, while transmitting the light.

In the embodiment shown in FIG. 4A, the compensation plate 407 may be referred to as a second compensation plate 407, which may be disposed between the second R-PVH element 203 and the third R-PVH element 205. The second compensation plate 407 may be configured to control a polarization of a light after the light is output from the second R-PVH element 203 and before the light is incident onto the third R-PVH element 205. The light may be associated with the operating wavelength range of the third R-PVH element 205. The light output from the second R-PVH element 203 may be a depolarized light, e.g., having a non-circular polarization, due to the excess phase retardance introduced by a combination of the first R-PVH element 201, the first compensation plate 405, and the second R-PVH element 203. The second compensation plate 407 may be configured to compensate for the polarization deviation of the light output from the second R-PVH element 203. The second compensation plate 407 may convert the polarization state of the light output from the second R-PVH element 203 from the non-circular polarization to a predetermined circular polarization, while transmitting the light.

In some embodiments, the R-PVH elements 201, 203, and 205 may be R-PVH gratings, and the apochromatic PVH device 400 may function as an apochromatic beam deflector with an increased diffraction efficiency in a target diffraction direction. In some embodiments, the R-PVH elements 201, 203, and 205 may be R-PVH lenses, and the apochromatic PVH device 400 may function as an apochromatic PVH lens with increased diffraction efficiencies in a plurality of target diffraction directions. For discussion purposes, in the embodiment shown in FIG. 4A, the R-PVH elements 201, 203, and 205 are shown as R-PVH gratings, which may be referred to as a first R-PVH grating 201, a second R-PVH grating 203, and a third R-PVH grating 205. For discussion purpose, the PVH gratings 201, 203 and 205 are presumed to have the same polarization selectivity, e.g., being left-handed PVH gratings.

For discussion purposes, an incident light 412 of the PVH device 400 may be a polychromatic light including a portion 412R of red color channel (e.g., the wavelength λ_{R}) (referred to as a red portion 412R), a portion 412G of green color channel (e.g., the wavelength λ_{G}) (referred to as a green portion 412G), and a portion 412B of blue color channel (e.g., the wavelength λ_{B}) (referred to as a blue portion 412B). For discussion purposes, the light 412 may be an LHCP polychromatic light. For discussion purposes, the light 412 may be substantially normally incident onto the PVH device 400. In other words, the light 412 may be a substantially on-axis or axis-parallel incident light of the PVH device 400. For illustrative purposes, the light 412 is shown as being incident onto the PVH device 400 from a side of the first R-PVH grating 201. In some embodiments, the light 412 may be incident onto the PVH device 400 from a side of the third R-PVH grating 205.

The first R-PVH grating 201 with the blue operating wavelength range may substantially backwardly diffract the blue portion 412B of the LHCP light 412 as an LHCP blue light 422B in a target diffraction angle θ with respect to a normal of a light outputting surface (that is also a light inputting surface) of the first R-PVH grating 201. The thickness of the first R-PVH grating 201 may be specifically configured or designed based on the disclosed principle to suppress the backward diffraction of a green light (e.g., the green portion 412G) and a red light (e.g., the red portion 412R). Thus, the first R-PVH grating 201 may substantially transmit, with negligible diffraction, the green portion 412G and the red portion 412R of the LHCP light 412 as a green light 414G and a red light 414R, respectively, toward the first compensation plate 405. The first R-PVH grating 201 may provide excess phase retardances to the green portion 412G and the red portion 412R of the LHCP light 412, while transmitting the green portion 412G and the red portion 412R of the LHCP light 412. Thus, the green light 414G and red light 414R output from the first R-PVH grating 201 may be depolarized lights, e.g., having non-circular polarizations.

The first compensation plate 405 may be configured to compensate for the polarization deviation of the green light 414G output from the first R-PVH grating 201. The first compensation plate 405 may adjust the polarization state of the green light 414G to the left-handed circular polarization, while transmitting the green light 414G. For example, the first compensation plate 405 may transmit the green light 414G as an LHCP green light 416G propagating toward the second R-PVH grating 203.

In the embodiment shown in FIG. 4A, the first compensation plate 405 is presumed to only compensate for the polarization deviation of the green light 414G, and not compensate for the polarization deviation of the red light 414R output from the first R-PVH grating 201. The first compensation plate 405 may provide an excess phase retardance to the red light 414R while transmitting the red light 414R. For example, the first compensation plate 405 may transmit the red light 414R as a red light 416G with a polarization other than the left-handed circular polarization.

The second R-PVH grating 203 with the green operating wavelength range may substantially backwardly diffract the LHCP green light 416G as an LHCP green light 422G in the target diffraction angle θ with respect to a normal of a light outputting surface (that is also a light inputting surface) of the second R-PVH grating 203. The LHCP green light 422G may propagate toward the first compensation plate 405 and the first R-PVH grating 201. The combination of the first compensation plate 405 and the first R-PVH grating 201 may substantially maintain at least one (e.g., all) of the propagation direction, the wavefront, or the polarization of the LHCP green light 422G. Thus, the combination of the first compensation plate 405 and the second R-PVH grating 203 may substantially backwardly diffract the green portion 412G of the LHCP light 412 as the LHCP green light 422G in the target diffraction angle θ.

As the thickness of the second R-PVH grating 203 is specifically configured or designed based on the disclosed principle to suppress the backward diffraction of a red light (e.g., the red light 416R), the second R-PVH grating 203 may substantially transmit, with negligible diffraction, the red light 416R toward the second compensation plate 417. The second R-PVH grating 203 may provide an excess phase retardance to the red light 416R while transmitting the red light 416R. For example, the second R-PVH grating 203 may transmit the red light 416R as a red light 418R with a polarization other than the left-handed circular polarization. The red light 418R may propagate toward the second compensation plate 407.

The second compensation plate 407 may be configured to compensate for the polarization deviation of the red light 418R output from the second R-PVH grating 203. The polarization deviation of the red light 418R may result from the excess phase retardance introduced by the combination of the first R-PVH grating 201, the first compensation plate 405, and the second R-PVH grating 203. The second compensation plate 407 may adjust the polarization state of the red light 418R to the left-handed circular polarization while transmitting the red light 418R. For example, the second compensation plate 407 may transmit the red light 418R as an LHCP red light 420R.

The third R-PVH grating 205 with the red operating wavelength range may substantially backwardly diffract the LHCP red light 420R as an LHCP red light 422R in the target diffraction angle θ with respect to a normal of a light outputting surface (that is also a light inputting surface) of the third R-PVH grating 205. The LHCP red light 422R may propagate toward the second compensation plate 407, the second R-PVH grating 203, the first compensation plate 405, and the first R-PVH grating 201. The combination of the second compensation plate 407, the second R-PVH grating 203, the first compensation plate 405, and the first R-PVH grating 201 may substantially maintain at least one (e.g., all) of the propagation direction, the wavefront, or the polarization of the LHCP red light 422R. Thus, the combination of the second compensation plate 407 and the third R-PVH grating 205 may substantially backwardly diffract the red portion 412R of the LHCP light 412 as the LHCP red light 422R in the target diffraction angle θ.

Thus, the PVH device 400 may respectively backwardly diffract the blue portion 412B, the green portion 412G, and the red portion 412R of the LHCP incident light 412 as the LHCP blue light 422B, the LHCP green light 422G, and the LHCP red light 422R having the common diffraction angle θ, with reduced color crosstalk, increased S/N ratio, and increased diffraction efficiency in the target diffraction direction. In other words, the PVH device 200 may diffract the blue portion 412B, the green portion 412G, and the red portion 412R of the LHCP light 412 in the common diffraction angle θ, with reduced color crosstalk, increased S/N ratio, and increased diffraction efficiency. At an output side of the PVH device 400, the LHCP blue light 422B, the LHCP green light 422G, and the LHCP red light 422R may be combined as a polychromatic LHCP light 422 that is steered (or deflected) in the common steering angle θ with respect to a normal of a light outputting surface (that is also a light inputting surface) of the PVH device 400.

FIG. 4B schematically illustrates an x-z sectional view of an apochromatic PVH device 430, according to an embodiment of the present disclosure. The apochromatic PVH device 430 may include elements that are the same as or similar to those included in the apochromatic PVH device 200 shown in FIG. 2A, the apochromatic PVH device 230 shown in FIG. 2B, or the apochromatic PVH device 400 shown in FIG. 4A. Descriptions of the same or similar elements may refer to the above descriptions rendered in connection with FIG. 2A, FIG. 2B, or FIG. 4A.

As shown in FIG. 4B, the PVH device 430 may include a plurality of (e.g., three) R-PVH elements 201, 203, and 205, and a plurality of compensation plates 405 and 407 alternately arranged with the R-PVH elements 201, 203, and 205. In the embodiment shown in FIG. 2B, the R-PVH elements 201, 203, and 205 may be R-PVH lenses, which are also referred to as a first R-PVH lens 201, a second R-PVH lens 203, and a third R-PVH lens 205 for discussion purposes. The apochromatic PVH device 430 may function as an apochromatic PVH lens (also referred to as 430 for discussion purposes) with increased diffraction efficiencies in a plurality of target diffraction directions.

In the embodiment shown in FIG. 4B, the local thicknesses of at least one (e.g., each) of the R-PVH lenses 201, 203, or 205 with the corresponding operating wavelength band may be specifically configured or designed, such that the local backward diffraction efficiency for a circularly polarized light having a wavelength outside of the corresponding operating wavelength band (a noise light) is less than the first predetermined value (e.g., 0.08%, 0.07%, 0.06%, 0.05%, 0.04%, 0.03%, 0.02%, or 0.01%), or the local S/N ratio associated with the backward diffractions of a signal light and the noise light is greater than the second predetermined value (e.g., 100). In other words, at least one (e.g., each) of the R-PVH lenses 201, 203, or 205 may be configured to substantially transmit, with negligible diffraction, the circularly polarized light having the wavelength range outside of the corresponding operating wavelength band.

For discussion purpose, the PVH lenses 201, 203 and 205 are presumed to have the same polarization selectivity, e.g., being left-handed PVH lenses. For discussion purposes, an incident light 432 of the PVH device 430 may be a polychromatic light including a red portion 432R, a green portion 432G, and a blue portion 432B. For discussion purposes, the light 432 may be an LHCP polychromatic light. For discussion purposes, the light 432 may be substantially normally incident onto the PVH device 430. In other words, the light 432 may be a substantially on-axis or axis-parallel incident light of the PVH device 430. For illustrative purposes, the light 432 is shown as being incident onto the PVH device 430 from a side of the first R-PVH lens 201. In some embodiments, the light 432 may be incident onto the PVH device 430 from a side of the third R-PVH lens 205.

In the embodiment shown in FIG. 4B, the first R-PVH lens 201 with the blue operating wavelength range may substantially backwardly diffract the blue portion 432B of the LHCP light 432 as an LHCP blue light 442B that is focused to a target focal point F. In other words, the first R-PVH lens 201 may focus, via backward diffraction, the blue portion 432B of the LHCP light 432 to the target focal point F. As the local thicknesses of the first R-PVH lens 201 are configured based on the disclosed principle to suppress diffraction of the green portion 432G and the red portion 432R, the first R-PVH lens 201 may substantially transmit, with negligible diffraction, the green portion 432G and the red portion 432R as a green light 434G and a red light 434R, respectively, toward the first compensation plate 405. The first R-PVH lens 201 may provide excess phase retardances to the green portion 432G and the red portion 432R, while transmitting the green portion 432G and the red portion 432R. Thus, the green light 434G and red light 434R output from the first R-PVH lens 201 may be depolarized lights, e.g., having non-circular polarizations.

The first compensation plate 405 may be configured to compensate for the polarization deviation of the green light 434G output from the first R-PVH lens 201. The first compensation plate 405 may adjust the polarization state of the green light 434G to the left-handed circular polarization while transmitting the green light 434G. For example, the first compensation plate 405 may transmit the green light 434G as an LHCP green light 436G propagating toward the second R-PVH lens 203.

In the embodiment shown in FIG. 4B, the first compensation plate 405 is presumed to not compensate for the polarization deviation of the red light 434R output from the first R-PVH element 201. The first compensation plate 405 may provide an excess phase retardance to the red light 434R while transmitting the red light 434R. For example, the first compensation plate 405 may transmit the red light 434R as a red light 436R with a polarization other than the left-handed circular polarization.

The second R-PVH lens 203 with the green operating wavelength range may substantially backwardly diffract the LHCP green light 436G as an LHCP green light 442G that is focused to the target focal point F. In other words, the combination of the first compensation plate 405 and the second R-PVH lens 203 may focus, via backward diffraction, the green portion 432G of the LHCP light 432 to the target focal point F. The LHCP green light 442G may propagate toward the first compensation plate 405 and the first R-PVH lens 201. The combination of the first compensation plate 405 and the first R-PVH lens 201 may substantially maintain at least one (e.g., all) of the propagation direction, the wavefront, or the polarization of the LHCP green light 442G. Thus, the combination of the first compensation plate 405 and the second R-PVH lens 203 may focus, via backward diffraction, the green portion 432G of the LHCP light 432 to the target focal point F.

As the thickness of the second R-PVH lens 203 is specifically configured or designed based on the disclosed principle to suppress the diffraction of a red light (e.g., the red light 436R), the second R-PVH lens 203 may substantially transmit, with negligible diffraction, the red light 436R toward the second compensation plate 437. The second R-PVH lens 203 may provide an excess phase retardance to the red light 436R while transmitting the red light 436R. For example, the second R-PVH lens 203 may transmit the red light 436R as a red light 438R with a polarization other than the left-handed circular polarization. The red light 438R may propagate toward the second compensation plate 407.

The second compensation plate 407 may be configured to compensate for the polarization deviation of the red light 438R output from the second R-PVH lens 203. The polarization deviation of the red light 438R may result from the excess phase retardance introduced by the combination of the first R-PVH lens 201, the first compensation plate 405, and the second R-PVH lens 203. The second compensation plate 407 may adjust the polarization state of the red light 438R to the left-handed circular polarization while transmitting the red light 438R. For example, the second compensation plate 407 may transmit the red light 438R as an LHCP red light 440R.

The third R-PVH lens 205 with the red operating wavelength range may substantially backwardly diffract the LHCP red light 440R as an LHCP red light 442R that is focused to the target focal point F. The LHCP red light 442R may propagate toward the second compensation plate 407, the second R-PVH lens 203, the first compensation plate 405, and the first R-PVH lens 201. The combination of the second compensation plate 407, the second R-PVH lens 203, the first compensation plate 405, and the first R-PVH lens 201 may substantially maintain at least one (e.g., all) of the propagation direction, the wavefront, or the polarization of the LHCP red light 442R. Thus, the combination of the second compensation plate 407 and the third R-PVH lens 205 may focus, via backward diffraction, the red portion 432R of the LHCP light 432 to the target focal point F.

Thus, the PVH device 430 may respectively backwardly diffract the blue portion 432B, the green portion 432G, and the red portion 432R of the LHCP light 432 as the LHCP blue light 442B, the LHCP green light 442G, and the LHCP red light 442R that are focused to the common focal point F, with reduced color crosstalk, increased S/N ratio, and increased diffraction efficiencies in a plurality of target diffraction directions. In other words, the PVH device 430 may focus the polychromatic, LHCP light 432 to the common focal point, with reduced color crosstalk, increased S/N ratio F, and increased diffraction efficiency. At an output side of the PVH device 430, the LHCP blue light 442B, the LHCP green light 442G, and the LHCP red light 442R may form a polychromatic LHCP light 442 that is focused to the common focal point F.

Referring to FIGS. 4A and 4B, the compensation plates 405 and 407 may be compensation plates of a first type. In some embodiments, the apochromatic PVH devices disclosed herein may include one or more compensation plates of a second type alternately arranged with the R-PVH elements 201, 203, and 205. In some embodiments, the R-PVH elements 201, 203, and 205 may provide different phase retardances for an axis-parallel light (or ray) of a predetermined color channel and an off-axis light (or ray) of the predetermined color channel. In some embodiments, in addition to a desirable phase retardance provided to each of the axis-parallel light (or ray) of a predetermined color channel and an off-axis light (or ray) of the predetermined color channel, the R-PVH element 201, 203, or 205 may provide an undesirable phase retardance to the off-axis light (or ray) of the predetermined color channel, which may degrade the apochromatic performance of the PVH device.

The one or more compensation plates of the second type may be configured to compensate for the undesirable phase retardance experienced by an off-axis light of the predetermined color channel when the off-axis light is reflected by or transmits through the R-PVH element 201, 203, or 205, thereby enhancing the angular performance of the apochromatic PVH devices disclosed herein. In some embodiments, the one or more compensation plates of the second type may include one or more uniaxial compensation plates and/or one or more biaxial compensation plates. In some embodiments, the uniaxial compensation plate may include a C-plate, an O-plate, etc. Due to the compensation effect of the one or more compensation plates of the second type, the apochromatic PVH device may be configured to focus both of a substantially on-axis or axis-parallel polychromatic light and an off-axis polychromatic light to a single common focal point, or may steer (or deflect) both of the substantially on-axis or axis-parallel polychromatic light and the off-axis polychromatic light in a single common (or same) steering (or deflecting) angle.

Referring to FIGS. 2A and 2B and FIGS. 4A and 4B, the apochromatic PVH devices disclosed herein are designed based on three wavelengths within the red, green, and blue color channels: λ_{R}=635 nm, λ_{G}=530 nm, and λ_{B}=450 nm. In such an embodiment, the red color channel may correspond to a wavelength of λ_{R}=635 nm, the green color channel may correspond to a wavelength of λG=530 nm, and the blue color channel corresponds to a wavelength of λ_{B}=450 nm. In some embodiments, the apochromatic PVH devices disclosed herein may be designed based on three wavelengths within the red, green, and blue color channels other than λ_{R}=635 nm, λ_{G}=530 nm, and λ_{B}=450 nm.

Referring to FIGS. 2A and 2B and FIGS. 4A and 4B, the apochromatic PVH devices disclosed herein include apochromatic PVH beam deflectors and apochromatic PVH lenses, which are for illustrative purposes. Any suitable apochromatic PVH devices may also be configured, following the same design principles for the apochromatic PVH beam deflectors and apochromatic PVH lenses disclosed herein, such as an apochromatic off-axis PVH lens, an apochromatic cylindrical PVH lens, an apochromatic aspheric PVH lens, an apochromatic freeform PVH lens, etc.

In some embodiments, apochromatic PVH devices that operate for any suitable spectral region (e.g., IR spectral region, UV spectral region) and/or that include any suitable number of R-PVH elements may also be configured, following the same design principles for the apochromatic PVH devices operating for the visible spectral region. In some embodiments, achromatic PVH devices operating for the visible spectral region may be designed based on two wavelengths: λ_{R}=635 nm and λ_{B}=450 nm, following the same or similar design principles for the apochromatic PVH devices operating for the visible spectral region. For example, in some embodiments, an achromatic PVH device may include two PVH elements. One PVH element may have the operation wavelength range associated with the red color channel, and the other PVH element may have the operation wavelength range associated with the blue color channel, similar to that shown in FIGS. 2A and 2B. In some embodiments, an achromatic PVH device may include two PVH elements, and a compensation plate (e.g., an A-plate) disposed between the two PVH elements, similar to that shown in FIGS. 4A and 4B.

In some embodiments, an achromatic PVH device may also include one or more other type compensation plates (e.g., C-plates) configured to enhance the angular performance of the achromatic PVH device. In some embodiments, achromatic PVH devices that operate for any suitable spectral region (e.g., IR spectral region, UV spectral region) and/or that include any suitable number of R-PVH elements may also be configured, following the same design principles for the achromatic PVH devices operating for the visible spectral region.

In the above described principle, when configuring the thickness of an R-PVH element with an operating wavelength band corresponding to a first color based on the S/N ratios associated with the backward diffraction of a signal light and at least one noise light or at least two noise lights (e.g., lights of at least one or at least two other colors), multiple candidate thicknesses may satisfy the condition of S/N ratios being greater than the second predetermined value. The design of the device may impose a condition that the thickness be within a specific design range. When only one of the multiple candidate thicknesses falls within the specific design range, that one can be selected as the optimal thickness. When two or more candidate thicknesses fall within the specific design range, the smallest candidate thickness may be selected as the thickness for the R-PVH element. In addition, a variation between local thicknesses may be selected to be equal to smaller than a predetermined thickness value. For example, the optimal local thicknesses are selected for achieving a small variation.

The apochromatic PVH devices or components disclosed herein have features of small thickness (˜1 um), high monochromatic and apochromatic efficiency (≥98%), superfast power (f-number≤0.5 for a lens, beam deflection angle≥45° for a beam deflector), low color crosstalk (or high S/N ratio), light weight, compactness, no limitation of aperture, simple fabrication, etc. The apochromatic PVH devices disclosed herein may be implemented in systems or devices for imaging, sensing, communication, biomedical applications, etc. Beam steering devices based on the disclosed apochromatic PVH devices may be implemented in various systems for augmented reality (“AR”), virtual reality (“VR”), and/or mixed reality (“MR”) applications, e.g., near-eye displays (“NEDs”), head-up displays (“HUDs”), head-mounted displays (“HMDs”), smart phones, laptops, televisions, vehicles, etc. For example, beam steering devices based on the disclosed apochromatic PVH devices may be implemented in displays and optical modules to enable pupil steered AR, VR, and/or MR display systems, such as holographic near eye displays, retinal projection eyewear, and wedged waveguide displays. Pupil steered AR, VR, and/or MR display systems have features such as compactness, large field of views (“FOVs”), high system efficiencies, and small eye-boxes. Beam steering devices based on the disclosed polarization selective devices may be implemented in the pupil steered AR, VR, and/or MR display systems to enlarge the eye-box spatially and/or temporally. In some embodiments, beam steering devices based on the disclosed apochromatic PVH devices or components may be implemented in AR, VR, and/or MR sensing modules to detect objects in a wide angular range to enable other functions. In some embodiments, beam steering devices based on the disclosed apochromatic PVH devices or components may be implemented in AR, VR, and/or MR sensing modules to extend the FOV (or detecting range) of the sensors in space constrained optical systems, increase detecting resolution or accuracy of the sensors, and/or reduce the signal processing time. Beam steering devices based on the disclosed apochromatic PVH devices or components may also be used in Light Detection and Ranging (“Lidar”) systems in autonomous vehicles. Beam steering devices based on the disclosed apochromatic PVH devices or components may also be used in optical communications, e.g., to provide fast speeds (e.g., speeds at the level of Gigabyte/second) and long ranges (e.g., ranges at kilometer levels). Beam steering devices based on the disclosed apochromatic PVH devices or components may also be implemented in microwave communications, 3D imaging and sensing (e.g., Lidar), lithography, and 3D printing, etc.

Imaging devices based on the disclosed apochromatic PVH devices may be implemented in various systems for AR, VR, and/or MR applications, enabling light-weight and ergonomic designs for AR, VR, and/or MR devices. For example, imaging devices based on the disclosed apochromatic PVH devices may be implemented in displays and optical modules to enable smart glasses for AR, VR, and/or MR applications, compact illumination optics for projectors, light-field displays. Imaging devices based on the disclosed apochromatic PVH devices may be implemented in HUDs for vehicles. The disclosed apochromatic PVH lenses may replace conventional objective lenses having a high numerical aperture in microscopes. The disclosed apochromatic PVH lenses may be implemented into light source assemblies to provide a polarized structured illumination to a sample, for identifying various features of the sample. The disclosed apochromatic PVH lenses may be used as compact laser backlight units. The disclosed apochromatic PVH lenses may enable polarization patterned illumination systems that add a new degree for sample analysis.

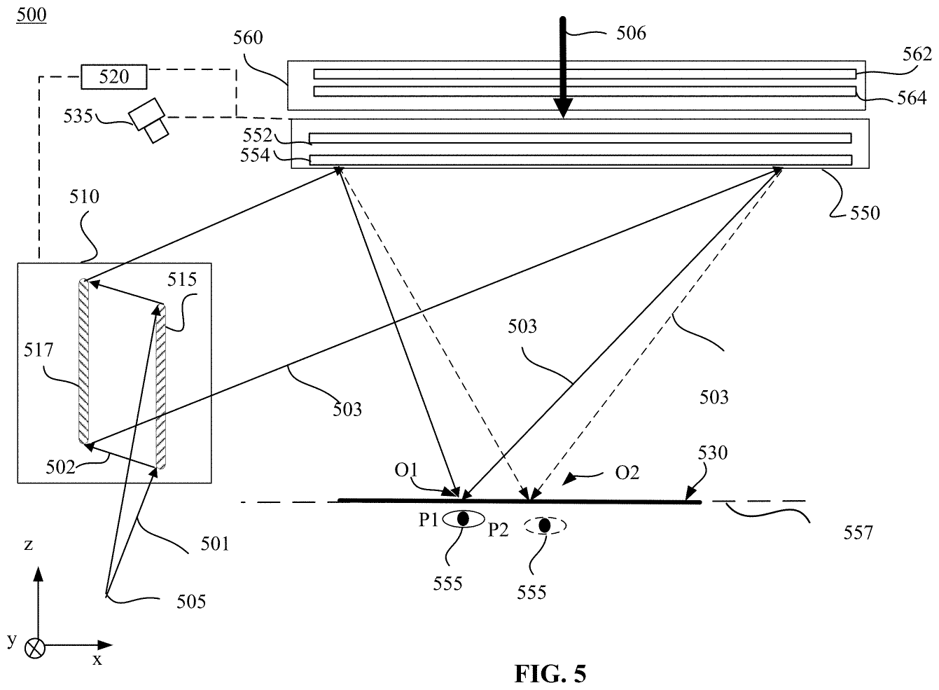

FIG. 5 schematically illustrates a diagram of an optical system 500, according to an embodiment of the present disclosure. The optical system 500 may be a display system 500. In some embodiments, the display system 500 may be a holographic display system. In some embodiments, the holographic display system may be implemented in an NED for AR, VR, and/or MR applications. As shown in FIG. 5, the display system 500 may include a light source 505, a light conditioning device 510, an image combiner 550 including a reflective lens 552 and a beam steering device 554, an eye-tracking device 535, and a controller 520. The controller 520 may be electrically coupled with and control various devices in the display system 500, including, but not limited to, the light source 505, the eye-tracking device 535, and the beam steering device 554. The beam steering device 554 may be disposed at a side of the reflective lens 552 facing a user.

In some embodiments, the light source 505 may include a point light source configured to generate a coherent or partially coherent beam 501 that is convergent or divergent. The light source 505 may include, e.g., a laser diode, a fiber laser, a vertical cavity surface emitting laser, a light emitting diode, or any combination thereof. The light conditioning device 510 may include one or more optical components configured to condition the beam 501 generated by the light source 505, and output a beam 503 with desirable properties toward the beam steering device 554. In some embodiments, conditioning the beam 501 may include, e.g., polarizing, expanding, and/or changing a propagation direction, etc., of the beam 501. In some embodiments, the controller 520 may control the light conditioning device 510 to condition the beam 501. In some embodiments, the light source 505 may include a single optical fiber coupled to three laser diodes emitting red, green, and blue laser beams, respectively. For example, the red, green, and blue laser beams may have a central wavelength of about 450 nm, 530 nm, and 635 nm, respectively.

In some embodiments, the light conditioning device 510 may include a first optical element 515 and a second optical element 517. In some embodiments, the first optical element 515 may include a front HOE (also referred to as 515 for discussion purposes). In some embodiments, the second optical element 517 may include a spatial light modulator (“SLM”) (also referred to as 517 for discussion purposes). The front HOE 515 may be configured to reflect (e.g., backwardly diffract) the beam 501 received from the light source 505 as a beam 502 to illuminate the SLM 517, such that an optical path of the beam 501 from the light source 505 to the SLM 517 may be folded for achieving a compact form factor. In addition, the size of the front HOE 515 and the light source 505 may also be made sufficiently small to reduce the form factor. In some embodiments, the beam 502 directed by the front HOE 515 may cover an entire active area of the SLM 517.

In some embodiments, the front HOE 515 may also be configured to further expand the beam 501, such that the expanded beam may cover an entire active area of the SLM 517. In some embodiments, the front HOE 515 may include a fixed hologram configured to expand the beam 501 as the beam 502, and direct the expanded beam 502 to the SLM 517. The expanded beam 502 may cover the entire active area of the SLM 517. In some embodiments, the front HOE 515 may be angularly selective such that the front HOE 515 may substantially reflect (e.g., backwardly diffract) the beam 501 having an incidence angle within a predetermined incidence angle range, but may not reflect (e.g., backwardly diffract) a beam having an incidence angle outside of the predetermined incidence angle range. In some embodiments, the front HOE 515 may be multiplexed, such that the front HOE 515 may be configured to have a high diffraction efficiency at multiple wavelengths, e.g., those within red, green, and blue spectrum, respectively.

The SLM 517 may be configured to modulate the beam 502 reflected (e.g., backwardly diffracted) from the front HOE 515. For example, the SLM 517 may be configured to modulate the amplitude, phase, and/or the polarization of the beam 502 in space and/or time, to provide a computer-generated hologram for generating a display image. Any suitable SLM 517 may be used. For example, the SLM 517 may include an LC material. In some embodiments, the SLM 517 may include a translucent or reflective LC micro display. In some embodiments, the SLM 517 may include a homeotropically aligned nematic LC cell, a homogeneously aligned nematic LC cell, or a twisted nematic LC cell. In some embodiments, the SLM 517 may be electrically programmed to modulate the beam 502 based on a fixed spatial (or pixel) pattern.

The modulated beam 503 corresponding to the hologram generated by the SLM 517 may be incident onto the image combiner 550 including the reflective lens 552 and the beam steering device 554. The image combiner 550 may include one or more disclosed apochromatic PVH devices or components. For example, the reflective lens 552 may include one or more disclosed apochromatic PVH lenses, such as the apochromatic PVH lens 230 shown in FIG. 2B, or the apochromatic PVH lens 430 shown in FIG. 4B. The beam steering device 554 may include one or more disclosed apochromatic PVH beam deflectors, such as the apochromatic PVH beam deflector 200 shown in FIG. 2A, or the apochromatic PVH beam deflector 400 shown in FIG. 4A.

The image combiner 550 may steer and focus the modulated beam 503 (e.g., a polychromatic light) received from the SLM 517 to one or more spots at an image plane 557 where one or more exit pupils of the display system 500 is located. For example, the reflective lens 552 may reflect and focus the modulated beam 503 (e.g., a polychromatic light) to a common focal point. The beam steering device 554 may deflect the modulated beam 503 to one or more spots at an image plane 557 where one or more exit pupils of the display system 500 is located. An exit pupil may be a location where an eye pupil 555 of a user is positioned in an eye-box region 530 of the display system 500. In some embodiments, one or more exit pupils may be simultaneously available at the eye-box 530. In some embodiments, one or more exit pupils may be arranged in a one-dimensional (“1D”) or a two-dimensional (“2D”) array within the eye-box 530.

The eye-tracking device 535 may be configured to provide eye-tracking information relating to the eye pupil 555 of the user of the display stem 500. Any suitable eye-tracking device 535 may be used. The eye-tracking device 535 may include, e.g., one or more light sources that illuminate one or both eyes of the user, and one or more cameras that capture images of one or both eyes. The eye-tracking device 535 may be configured to track a position, a movement, and/or a viewing direction of the eye pupil 555. In some embodiments, the eye-tracking device 535 may measure the eye position and/or eye movement up to six degrees of freedom for each eye (i.e., 3D positions, roll, pitch, and yaw). In some embodiments, the eye-tracking device 535 may measure a pupil size. The eye-tracking device 535 may provide a signal (or feedback) containing the position and/or movement of the eye pupil 555 to the controller 520.

In some embodiments, based on the eye-tracking information from the eye-tracking device 535, the controller 520 may be configured to control the beam steering device 554 to steer and focus the beam 503 received from the SLM 517 to one or more spots at the image plane 557 where one or more exit pupils of the display system 500 is located. For illustrative purposes, only one spot is shown in FIG. 5. For illustrative purposes, FIG. 5 shows two operating states of the beam steering device 554. For example, at a first time instance or period, the eye-tracking device 535 may detect that the eye pupil 555 is located at a first position P1 within the eye-box 530. Based on the eye-tracking information, the controller 520 may control the beam steering device 554 to steer the beam 503 received from the light conditioning device 510 to a first exit pupil O1. The first exit pupil O1 may substantially coincide with the first position P1 of the eye pupil 555.

At a second time instance or period, the eye-tracking device 535 may detect that the eye pupil 555 has moved to a second position P2 at the eye-box 530. The eye-tracking device 535 may provide the new position information (as part of the eye-tracking information) to the controller 520. Alternatively, in some embodiments, the controller 520 may determine the new eye-tracking information based on images of the eye pupil 555 received from the eye-tracking device 535. The controller 520 may control the beam steering device 554 to steer the beam 503 received from the light conditioning device 510 to a second exit pupil O2. The second exit pupil O2 may substantially coincide with the second position P2 of the eye pupil 555.

In some embodiments, when used for AR applications, the image combiner 550 may be substantially transparent to a beam 506 from a real world environment. The image combiner 550 may combine the beam 503 (an image light) and the beam 506 from a real-world environment, and direct both beams toward the eye-box 530. The reflective lens 552 may be referred to as a first reflective lens 552, and the beam steering device 554 may be referred to as a first beam steering device 554. In some embodiments, when used for AR and/or MR applications, the display system 500 may further include a stack 560 of a second reflective lens 562 and a second beam steering device 564. For example, the first reflective lens 552 may have a first side facing the eye pupil 555 and a second side opposite to the first side. The stack 560 of the second reflective lens 562 and the second beam steering device 564 may be disposed at the second side of the first reflective lens 552.

The second reflective lens 562 and the second beam steering device 564 may be similar to the first reflective lens 552 and the first beam steering device 554, respectively. For example, the second reflective lens 562 may include one or more disclosed apochromatic PVH lenses, such as the apochromatic PVH lens 230 shown in FIG. 2B, or the apochromatic PVH lens 430 shown in FIG. 4B. The second beam steering device 564 may include one or more disclosed apochromatic PVH beam deflectors, such as the apochromatic PVH beam deflector 200 shown in FIG. 2A, or the apochromatic PVH beam deflector 400 shown in FIG. 4A.

The controller 520 may be communicatively coupled with the second reflective lens 562 and the second beam steering device 564 to control operations thereof. In some embodiments, when used for AR and/or MR applications, the controller 520 may be configured to control the second beam steering device 564 to provide opposite steering effects to the beam 506 from the real-world environment. The controller 520 may control the second reflective lens 562 to provide an opposite lensing effect to the beam 506 from the real-world environment. For example, the steering angles provided by the first beam steering device 554 and the second beam steering device 564 to the beam 506 may have opposite signs and a substantially same absolute value. The optical powers provided by the first reflective lens 552 and the second reflective lens 562 to the beam 506 may have opposite signs and a substantially same absolute value. Thus, the stack 560 of the second reflective lens 562 and the second beam steering device 564 may be configured to compensate for the distortion of the beam 506 (representing real-world images) caused by the stack of the first reflective lens 552 and the first beam steering device 554, such that images of the real-world objects viewed through the display system 500 may be substantially unaltered.

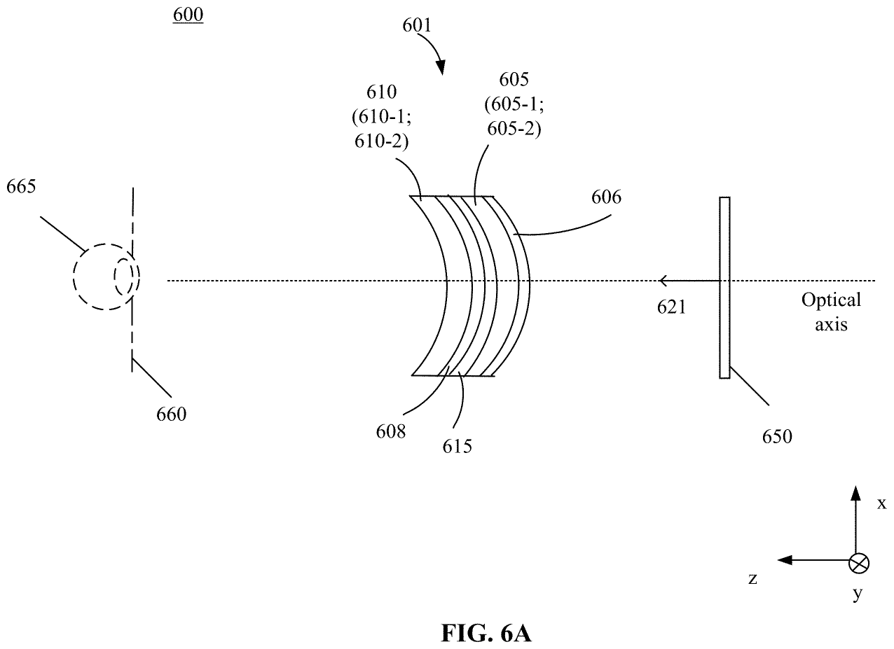

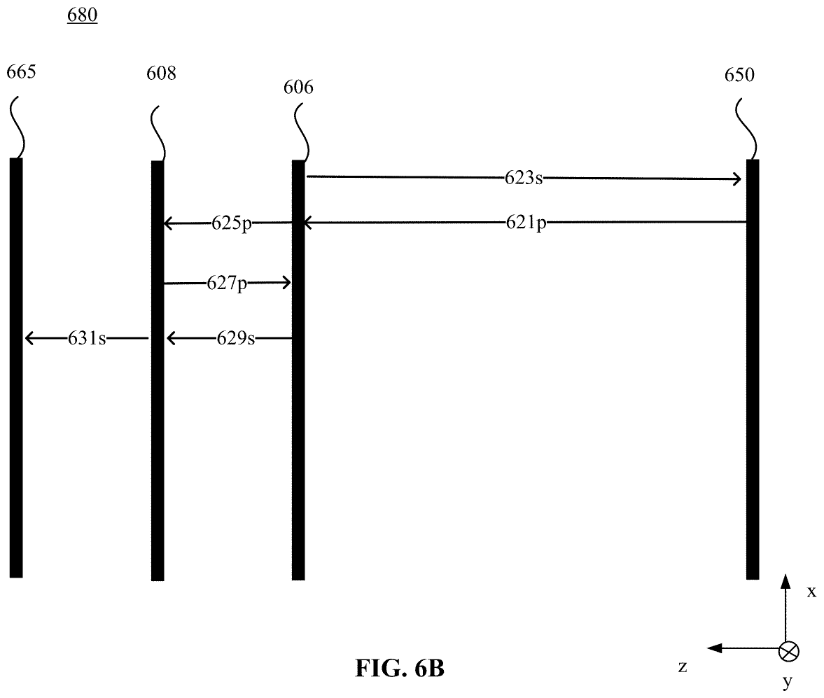

FIG. 6A illustrates a schematic diagram of an optical system 600 according to an embodiment of the present disclosure. The optical system 600 may include a display device 650, and a pancake lens assembly 601 coupled to the display device 650. The display device 650 may be configured to display a virtual image. In some embodiments, the display device 650 may be a monochromatic display device, e.g., a red, green, or blue display device. In some embodiments, the display device 650 may be a polychromatic display device, e.g., a red-green-blue (“RGB”) display device. In some embodiments, the display device 650 may be a polychromatic display device including a stack of a plurality of monochromatic displays, e.g., an RGB display device including a stack of red, green, and blue display devices.

As shown in FIG. 6A, the display device 650 may be configured to output a polarized image light 621 (that forms the virtual image) toward the pancake lens assembly 601. The pancake lens assembly 601 may be configured to focus the polarized image light 621 to an eye-box located at an exit pupil 660. The exit pupil 660 may be at a location where an eye 665 is positioned in an eye-box region when a user wears the NED. In some embodiments, the pancake lens assembly 601 may include a first optical element 605 and a second optical element 610. In some embodiments, the pancake lens assembly 601 may be configured as a monolithic pancake lens assembly without any air gaps between optical elements included in the pancake lens assembly. In some embodiments, one or more surfaces of the first optical element 605 and the second optical element 610 may be shaped (e.g., curved) to compensate for field curvature. In some embodiments, one or more surfaces of the first optical element 605 and/or the second optical element 610 may be shaped to be spherically concave (e.g., a portion of a sphere), spherically convex, a rotationally symmetric asphere, a freeform shape, or some other shape that can mitigate field curvature. In some embodiments, the shape of one or more surfaces of the first optical element 605 and/or the second optical element 610 may be designed to additionally compensate for other forms of optical aberration. In some embodiments, at least one of the first optical element 605 and/or the second optical element 610 may include one or more apochromatic PVH devices disclosed herein, such as the apochromatic PVH lens 230 shown in FIG. 2B, or the apochromatic PVH lens 430 shown in FIG. 4B.

In some embodiments, one or more of the optical elements within the pancake lens assembly 601 may have one or more coatings, such as an anti-reflective coating, to reduce ghost images and enhance contrast. In some embodiments, the first optical element 605 and the second optical element 610 may be coupled together by an adhesive 615. Each of the first optical element 605 and the second optical element 610 may include one or more optical lenses. In some embodiments, at least one of the first optical element 605 or the second optical element 610 may have at least one flat surface.

The first optical element 605 may include a first surface 605-1 facing the display device 650 and an opposing second surface 605-2 facing the eye 665. The first optical element 605 may be configured to receive an image light at the first surface 605-1 from the display device 650 and output an image light with an altered property at the second surface 605-2. The pancake lens assembly 601 may also include a mirror 606 that may be an individual layer, film, or coating disposed at (e.g., bonded to or formed at) the first optical element 605. The mirror 606 may be disposed at (e.g., bonded to or formed at) the first surface 605-1 or the second surface 605-2 of the first optical element 605.

For discussion purposes, FIG. 6A shows that the mirror 606 is disposed at (e.g., bonded to or formed at) the first surface 605-1. In some embodiments, the mirror 606 may be disposed at the second surface 605-2 of the first optical element 605. In some embodiments, the mirror 606 may be a partial reflector that is partially reflective to reflect a portion of a received light. In some embodiments, the mirror 606 may be configured to transmit about 50% and reflect about 50% of a received light, and may be referred to as a “50/50 mirror.”

The second optical element 610 may have a first surface 610-1 facing the first optical element 605 and an opposing second surface 610-2 facing the eye 665. The pancake lens assembly 601 may also include a linear reflective polarizer 608, which may be an individual layer, film, or coating disposed at (e.g., bonded to or formed at) the second optical element 610. The linear reflective polarizer 608 may be disposed at (e.g., bonded to or formed at) the first surface 610-1 or the second surface 610-2 of the second optical element 610 and may receive a light output from the mirror 606. For discussion purposes, FIG. 6A shows that the linear reflective polarizer 608 is disposed at (e.g., bonded to or formed at) the first surface 610-1 of the second optical element 610. That is, the linear reflective polarizer 608 may be disposed between the first optical element 605 and the second optical element 610. In some embodiments, the linear reflective polarizer 608 may be disposed at the second surface 610-2 of the second optical element 610.

The pancake lens assembly 601 shown in FIG. 6A is merely for illustrative purposes. In some embodiments, one or more of the first surface 605-1 and the second surface 605-2 of the first optical element 605 and the first surface 610-1 and the second surface 610-2 of the second optical element 610 may be curved surface(s) or flat surface(s). In some embodiments, the pancake lens assembly 601 may have one optical element or more than two optical elements.

FIG. 6B illustrates a schematic cross-sectional view of an optical path 680 of an image light propagating in the pancake lens assembly 601 shown in FIG. 6A, according to an embodiment of the present disclosure. In the light propagation path 680, the change of polarization of the image light is shown. The first optical element 605 and the second optical element 610, which are presumed to be lenses that do not affect the polarization of the light, are omitted for the simplicity of illustration. In FIG. 6B, “s” denotes an s-polarized light, and “p” denotes a p-polarized light. For illustrative purposes, the display device 650, the mirror 606, and the linear reflective polarizer 608 are illustrated as flat surfaces in FIG. 6B. In some embodiments, one or more of the display device 650, the mirror 606, and the linear reflective polarizer 608 may include a curved surface.

For discussion purposes, the display device 650 may output a p-polarized image light 621p covering a predetermined spectrum, such as a portion of the visible spectral range or substantially the entire visible spectral range. The mirror 606 may reflect a first portion of the p-polarized image light 621p as an s-polarized image light 623s toward the display device 650, and transmit a second portion of the p-polarized image light 621p as a p-polarized image light 625p toward the linear reflective polarizer 608. The s-polarized image light 623s may be absorbed by a linear polarizer disposed on top of the display device 650. For discussion purpose, the linear reflective polarizer 608 may be configured to substantially reflect a p-polarized light, and substantially transmit an s-polarized light. Thus, the linear reflective polarizer 608 may reflect the p-polarized image light 625p as a p-polarized image light 627p back toward the mirror 606. The mirror 606 may reflect the p-polarized image light 627p as an s-polarized image light 629s toward the linear reflective polarizer 608, which may be transmitted through the linear reflective polarizer 608 as an s-polarized image light 631s. The s-polarized image light 631s may be focused onto the eye 665.

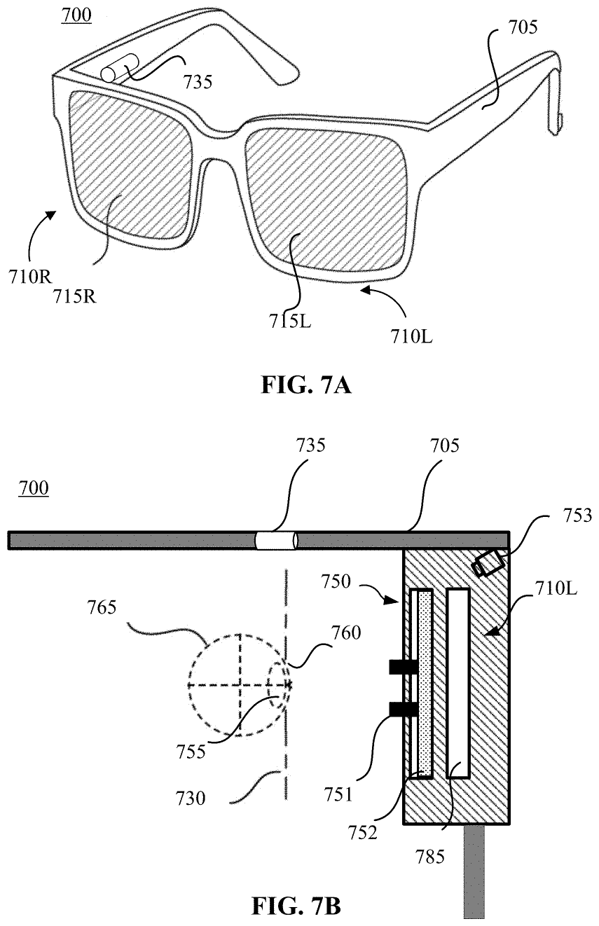

FIG. 7A illustrates a schematic diagram of a near-eye display (“NED”) 700 according to an embodiment of the disclosure. FIG. 7B is a cross-sectional view of half of the NED 700 shown in FIG. 7A according to an embodiment of the disclosure. For purposes of illustration, FIG. 7B shows the cross-sectional view associated with a left-eye display system 710L. The NED 700 may include a controller (not shown). The NED 700 may include a frame 705 configured to mount to a user's head. The frame 705 is merely an example structure to which various components of the NED 700 may be mounted. Other suitable fixtures may be used in place of or in combination with the frame 705. The NED 700 may include right-eye and left-eye display systems 710R and 710L mounted to the frame 705. The NED 700 may function as a VR device, an AR device, an MR device, or any combination thereof. In some embodiments, when the NED 700 functions as an AR or an MR device, the right-eye and left-eye display systems 710R and 710L may be entirely or partially transparent from the perspective of the user, which may provide the user with a view of a surrounding real-world environment. In some embodiments, when the NED 700 functions as a VR device, the right-eye and left-eye display systems 710R and 710L may be opaque, such that the user may be immersed in the VR imagery based on computer-generated images.

The right-eye and left-eye display systems 710R and 710L may include image display components configured to project computer-generated virtual images into left and right display windows 715L and 715R in a field of view (“FOV”). The right-eye and left-eye display systems 710R and 710L may be any suitable display systems. In some embodiments, the right-eye and left-eye display systems 710R and 710L may include one or more optical systems (e.g., display systems) disclosed herein, such as the optical system 500 shown in FIG. 5, or the optical system 600 shown in FIG. 6A. For illustrative purposes, FIG. 7A shows that the left-eye display systems 710L may include a light source assembly (e.g., a projector) 735 coupled to the frame 705 and configured to generate an image light representing a virtual image.

As shown in FIG. 7B, the left-eye display systems 710L may also include a viewing optical system 785 and an object tracking system 750 (e.g., eye tracking system and/or face tracking system). The viewing optical system 785 may be configured to guide the image light output from the left-eye display system 710L to an exit pupil 760. The exit pupil 760 may be a location where an eye pupil 755 of an eye 765 of the user is positioned in an eye-box region 730 of the left-eye display system 710L. In some embodiments, the viewing optical system 785 may be configured to correct aberrations in the image light output from the left-eye display system 710L, magnify the image light output from the left-eye display system 710L, or perform another type of optical adjustment to the image light output from the left-eye display system 710L. The viewing optical system 785 may include multiple optical elements, such as lenses, waveplates, reflectors, etc.

In some embodiments, the viewing optical system 785 may include a pancake lens assembly configured to fold the optical path, thereby reducing the back focal distance in the NED 700. The pancake lens assembly may be any embodiment of the pancake lens assemblies disclosed herein, such as the pancake lens assembly 601 shown in FIG. 6A. In some embodiments, the viewing optical system 785 may include a reflective lens (e.g., similar to the reflective lens 552 shown in FIG. 5) and a beam steering device (e.g., similar to the beam steering device 554 shown in FIG. 5). The reflective lens may include one or more disclosed apochromatic PVH lenses, such as the apochromatic PVH lens 230 shown in FIG. 2B, or the apochromatic PVH lens 430 shown in FIG. 4B. The beam steering device may include one or more disclosed apochromatic PVH beam deflectors, such as the apochromatic PVH beam deflector 200 shown in FIG. 2A, or the apochromatic PVH beam deflector 400 shown in FIG. 4A.

The object tracking system 750 may include an IR light source 751 configured to illuminate the eye 765 and/or the face, a deflecting element 752 configured to deflect the IR light reflected by the eye 765, and an optical sensor 753 configured to receive the IR light deflected by the deflecting element 752 and generate a tracking signal. In some embodiments, the object tracking system 750 may include one or more disclosed apochromatic PVH devices or components.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a first polarization hologram element having a first operating wavelength band and configured to selectively backwardly diffract or transmit a first light associated with the first operating wavelength band based on a polarization of the first light; and
a second polarization hologram element having a second operating wavelength band and stacked with the first polarization hologram,
wherein a thickness of the first polarization hologram element is configured based on a signal-to-noise ratio between a diffraction efficiency of the first polarization hologram element for the first light and a diffraction efficiency of the first polarization hologram element for a second light associated with the second operating wavelength band being greater than a predetermined value.

2. The device of claim 1, wherein the first light and the second light have a same predetermined polarization.

3. The device of claim 1, wherein the predetermined value is 100.

4. The device of claim 1, wherein
the second polarization hologram element is configured to selectively backwardly diffract or transmit the second light based on a polarization of the second light, and
a thickness of the second polarization hologram element is configured based on a signal-to-noise ratio between a diffraction efficiency of the second polarization hologram element for the second light and a diffraction efficiency of the second polarization hologram element for the first light being greater than the predetermined value.

5. The device of claim 1, wherein
the first polarization hologram element is configured to backwardly diffract the first light in a predetermined diffraction angle when the polarization of the first light is a predetermined polarization, and
the second polarization hologram element is configured to backwardly diffract the second light in the predetermined diffraction angle when the polarization of the second light is the predetermined polarization.

6. The device of claim 1, wherein
the first polarization hologram element is configured to backwardly diffract to focus the first light to a predetermined focal point when the polarization of the first light is the predetermined polarization, and
the second polarization hologram element is configured to backwardly diffract to focus the second light to the predetermined focal point when the polarization of the second light is the predetermined polarization.

7. The device of claim 1, wherein the first polarization hologram element and the second polarization hologram element are reflective polarization volume hologram (“R-PVH”) elements.

8. The device of claim 7, wherein the R-PVH elements include R-PVH gratings or R-PVH lenses.

9. The device of claim 1, wherein the first operating wavelength band and the second first operating wavelength band correspond to a first color channel and a second color channel, respectively.

10. The device of claim 1, further comprising a compensation plate disposed between the first polarization hologram element and the second polarization hologram element.

11. The device of claim 10, wherein the compensation plate is an A-plate.

12. The device of claim 1, further comprising:
a third polarization hologram element having a third operating wavelength band and stacked with the first and second polarization hologram elements,
wherein the thickness of the first polarization hologram element is configured also based on a signal-to-noise ratio between the diffraction efficiency of the first polarization hologram element for the first light and a diffraction efficiency of the first polarization hologram element for a third light associated with the third operating wavelength band being greater than the predetermined value.

13. The device of claim 12, wherein the first, second, and third lights have a same predetermined polarization.

14. The device of claim 12, wherein
the second polarization hologram element is configured to selectively backwardly diffract or transmit the second light based on a polarization of the second light, and
a thickness of the second polarization hologram element is configured based on a signal-to-noise ratio between a diffraction efficiency of the second polarization hologram element for the second light and a diffraction efficiency of the second polarization hologram element for the third light being greater than the predetermined value.

15. The device of claim 14, wherein
the thickness of the second polarization hologram element is configured also based on a signal-to-noise ratio between a diffraction efficiency of the second polarization hologram element for the second light and a diffraction efficiency of the second polarization hologram element for the first light being greater than the predetermined value.

16. The device of claim 12, wherein
the third polarization hologram element is configured to selectively backwardly diffract or transmit the third light based on a polarization of the third light, and
a thickness of the third polarization hologram element is configured based on a signal-to-noise ratio between a diffraction efficiency of the third polarization hologram element for the third light and a diffraction efficiency of the third polarization hologram element for at least one of the first light or the second light being greater than the predetermined value.

17. The device of claim 12, wherein
the first polarization hologram element is configured to backwardly diffract the first light in a predetermined diffraction angle when the polarization of the first light is a predetermined polarization,
the second polarization hologram element is configured to backwardly diffract the second light in the predetermined diffraction angle when the polarization of the second light is the predetermined polarization, and
the third polarization hologram element is configured to backwardly diffract the third light in the predetermined diffraction angle when the polarization of the third light is the predetermined polarization.

18. The device of claim 12, wherein
the first polarization hologram element is configured to backwardly diffract to focus the first light to a predetermined focal point when the polarization of the first light is a predetermined polarization,
the second polarization hologram element is configured to backwardly diffract to focus the second light to the predetermined focal point when the polarization of the second light is the predetermined polarization, and
the third polarization hologram element is configured to backwardly diffract to focus the third light to the predetermined focal point when the polarization of the third light is the predetermined polarization.

19. The device of claim 12, further comprising:
a first compensation plate disposed between the first polarization hologram element and the second polarization hologram element; and
a second compensation plate disposed between the second polarization hologram element and the third polarization hologram element.

20. The device of claim 19, wherein
the first compensation plate is configured to compensate for a polarization deviation of the second light after the second light propagates through the first polarization hologram element, and
the second compensation plate is configured to compensate for the polarization deviation of the third light after the third light propagates through the first polarization hologram element, the first compensation plate, and the second polarization hologram element.
